(19) United States
(12) Patent Application Publication
(10) Pub. No.: US 2010/0202386 A1
(43) Pub. Date: Aug. 12, 2010

(54) WIRELESS COMMUNICATION APPARATUS AND MAPPING METHOD

(75) Inventors: Shinsuke Takaoka, Kanagawa (JP); Masayuki Hoshino, Kanagawa (JP); Akihiko Nishio, Kanagawa (JP); Yasuaki Yuda, Kanagawa (JP); Ryohei Kimura, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/680,164

(22) PCT Filed: Sep. 26, 2008
(86) PCT No.: PCT/JP2008/002698

§ 371 Date: Mar. 25, 2010

(30) Foreign Application Priority Data
Sep. 28, 2007 (JP) 2007-256085
Jul. 3, 2008 (JP) 2008-174758

(51) Int. Cl. H04W 72/04

(52) U.S. Cl. 370/329

(57) ABSTRACT

A wireless communication apparatus wherein the power consumption can be reduced. In this apparatus, a code block dividing part (101) divides a transport block, in which filler bits have been inserted, into a plurality of code blocks. A mapping control part (107) controls, based on both scheduling information, which is received from a scheduler (not shown) and indicative of physical channel resources to be used for code block transmission, and the number of filler bits which is received from the code block dividing part (101), the plurality of code blocks so that they will be mapped to the respective physical channel resources in such an order that a respective code block having a less number of filler bits will be mapped to a respective more forward physical channel resource. A mapping part (108) then maps, based on mapping information received from the mapping control part (107), data symbols, which are received from the modulating parts (106) of the respective ones of code block processing parts (102-1 to 102-C), to the physical channel resources.

### TECHNICAL FIELD

The present invention relates to a radio communication apparatus and a mapping method.

### BACKGROUND ART

Since third-generation mobile communication services began, up till now, multimedia communication such as data communication and video communication has been gaining popularity. Therefore, data sizes are expected to increase even more in the future, and growing demands for higher data rates for mobile communication services are also anticipated.

Then, in 3GPP LTE (3rd Generation Partnership Project Long Term Evolution), to realize high speed transmission, 100 Mbps, studies are currently conducted for mobile communication standardization actively.

To realize this high speed transmission, error control techniques including FEC (Forward Error Correction code), ARQ (Automatic Repeat reQuest) and so on become a focus of attention. Further, HARQ (Hybrid ARQ) combining FEC and ARQ is studied. In 3GPP, HARQ using turbo codes for FEC is studied.

With turbo codes, a bit sequence is encoded per internal interleaver size in turbo codes. Here, if the size of a transport block, which is the information bit sequence provided from higher layer is beyond the interleaver size, the transport block is divided into a plurality of code blocks of the interleaver size. Here, if the transport block cannot be divided into a plurality of defined code block sizes, filler bits, which are known between the transmitting-side radio communication apparatus and the receiving-side radio communication apparatus, are inserted in the transport block. Then, the adjusted transport block is divided into a plurality of code blocks.

Further, with HARQ, using error detection codes including CRC (Cyclic Redundancy Check) codes, the receiving-side radio communication apparatus feeds back an ACK (Acknowledgement) signal as a response signal to the transmitting-side radio communication apparatus when there is no error in received data, and feeds back a NACK (Negative Acknowledgement) signal as a response signal to the transmitting-side radio communication apparatus when there is an error. Then, the receiving-side radio communication apparatus combines the data retransmitted from the transmitting-side radio communication apparatus, and the data received earlier with errors and performs error correction decoding for the combined data. By this means, SINR (Signal to Interference plus Noise power Ratio) improves and coding gain improves, so that it is possible to decode received data the smaller number of retransmission times than in normal ARQ.

In 3GPP, studies are conducted for two methods, a method of adding CRC bits in transport block units and a method of adding CRC bits in code block units, as methods of adding CRC bits to information bit sequences (e.g. see Non-Patent Document 1).

With the method of adding CRC bits in transport block units, after CRC bits are added to a transport block, that transport block is divided into a plurality of code blocks. With this method, CRC bits are added to the entire transport block, so that it is possible to reduce the overhead by the addition of CRC bits. Meanwhile, with the method of adding CRC bits in code block units, after a transport block is divided into a plurality of code blocks, CRC bits are added to each code block. By this means, a receiving-side radio communication apparatus is able to stop error correction processing on other code blocks upon detecting an error in any code block. Consequently, it is possible to reduce power consumption in decoding processing in the receiving-side radio communication apparatus and shorten the time to feed back a response signal to the transmitting-side radio communication apparatus. In both the method of adding CRC bits in transport block units and the method of adding CRC bits in code block units, retransmission is controlled in transport block units.

Further, in 3GPP, studies are underway to use a hybrid between the method of adding CRC bits in transport block units and the method of adding CRC bits in code block units (e.g. see Non-Patent Document 2). The transmitting-side radio communication apparatus divides a transport block with CRC bits into a plurality of code blocks, and, furthermore, adds CRC bits to each code block.
Non-Patent Document 1: “Analysis of per code block CRC and per transport block CRC,” 3GPP TSG RAN WG1 #49-bis, Orlando, 25-29 Jun. 2007
Non-Patent Document 2: “Way forward for CRC attachment for turbo-coded transport channel,” 3GPP TSG RAN WG1 #50, Athens, Aug. 20-24, 2007

### DISCLOSURE OF INVENTION

### Problems to be Solved by the Invention

Basically, it is preferable that the mobile communication terminal apparatus including a mobile phone driving with battery, consumes lower power. Therefore, when a radio communication apparatus that detects CRC bits on per code block is built in a mobile communication terminal apparatus, it is desirable to reduce power consumption.

It is therefore an object of the present invention to provide a radio communication apparatus and a mapping method that are able to reduce power consumption.

### Means for Solving the Problem

The radio communication apparatus of the present invention adopts a configuration including: a division section that divides a bit sequence, in which known bits are inserted, into a plurality of code blocks; and a mapping section that maps the plurality of code blocks in order from a code block with a smallest number of known bits, in order from a head of physical channel resources.

### Advantageous Effects of Invention

According to the present invention, it is possible to reduce power consumption.

### BRIEF DESCRIPTION OF DRAWINGS

FIG. 1 is a block diagram showing a configuration of a transmitting-side radio communication apparatus according to Embodiment 1 of the present invention;

FIG. 2 shows mapping processing according to Embodiment 1 of the present invention;

FIG. 3 shows mapping processing (mapping example 1) where there are a plurality of transmitting-side radio communication apparatuses according to Embodiment 1 of the present invention;

FIG. 4 shows mapping processing (mapping example 2) where there are a plurality of transmitting-side radio communication apparatuses according to Embodiment 1 of the present invention;

FIG. 5 shows mapping processing according to Embodiment 2 of the present invention (when the difference between code block sizes is equal to or more than a threshold value);

FIG. 6 shows mapping processing according to Embodiment 2 of the present invention (when the difference between code block sizes is less than a threshold value);

FIG. 7 is a block diagram showing a configuration of a transmitting-side radio communication apparatus according to Embodiment 3 of the present invention;

FIG. 8 shows mapping processing according to Embodiment 3 of the present invention (when the difference between coding rates is equal to or more than a threshold value);

FIG. 9 shows mapping processing according to Embodiment 3 of the present invention (when the difference between coding rates is less than a threshold value);

FIG. 10 is a block diagram showing a configuration of a transmitting-side radio communication apparatus according to Embodiment 4 of the present invention;

FIG. 11 shows mapping processing according to Embodiment 4 of the present invention (when the difference between frequency bandwidths is equal to or more than a threshold value);

FIG. 12 shows mapping processing according to Embodiment 4 of the present invention (when the difference between frequency bandwidths is less than a threshold value);

FIG. 13 is a block diagram showing a configuration of a transmitting-side radio communication apparatus according to Embodiment 5 of the present invention;

FIG. 14 is a block diagram showing a configuration of a receiving-side radio communication apparatus according to Embodiment 5 of the present invention;

FIG. 15 shows mapping processing according to Embodiment 5 of the present invention;

FIG. 16 shows another mapping processing according to Embodiment 5 of the present invention;

FIG. 17 shows mapping processing (mapping example 1) according to Embodiment 6 of the present invention;

FIG. 18 shows mapping processing (mapping example 2) according to Embodiment 6 of the present invention;

FIG. 19 shows another mapping processing (mapping example 1) according to Embodiment 6 of the present invention;

FIG. 20 shows another mapping processing (mapping example 2) according to Embodiment 6 of the present invention;

FIG. 21 shows another mapping processing according to Embodiment 6 of the present invention;

FIG. 22 shows another mapping processing according to Embodiment 6 of the present invention;

FIG. 23 shows another mapping processing (in single-site downlink multiple users) according to the present invention;

FIG. 24 shows another mapping processing (in single-site uplink multiple users) according to the present invention; and

FIG. 25 shows another mapping processing (in single-site uplink multiple users) according to the present invention.

### BEST MODE FOR CARRYING OUT THE INVENTION

Now, embodiments of the present invention will be described in detail with reference to the accompanying drawings.

### Embodiment 1

With the present embodiment, a plurality of code blocks are mapped in order from the code block with the smallest number of filler bits, in order from the head of physical channel resources.

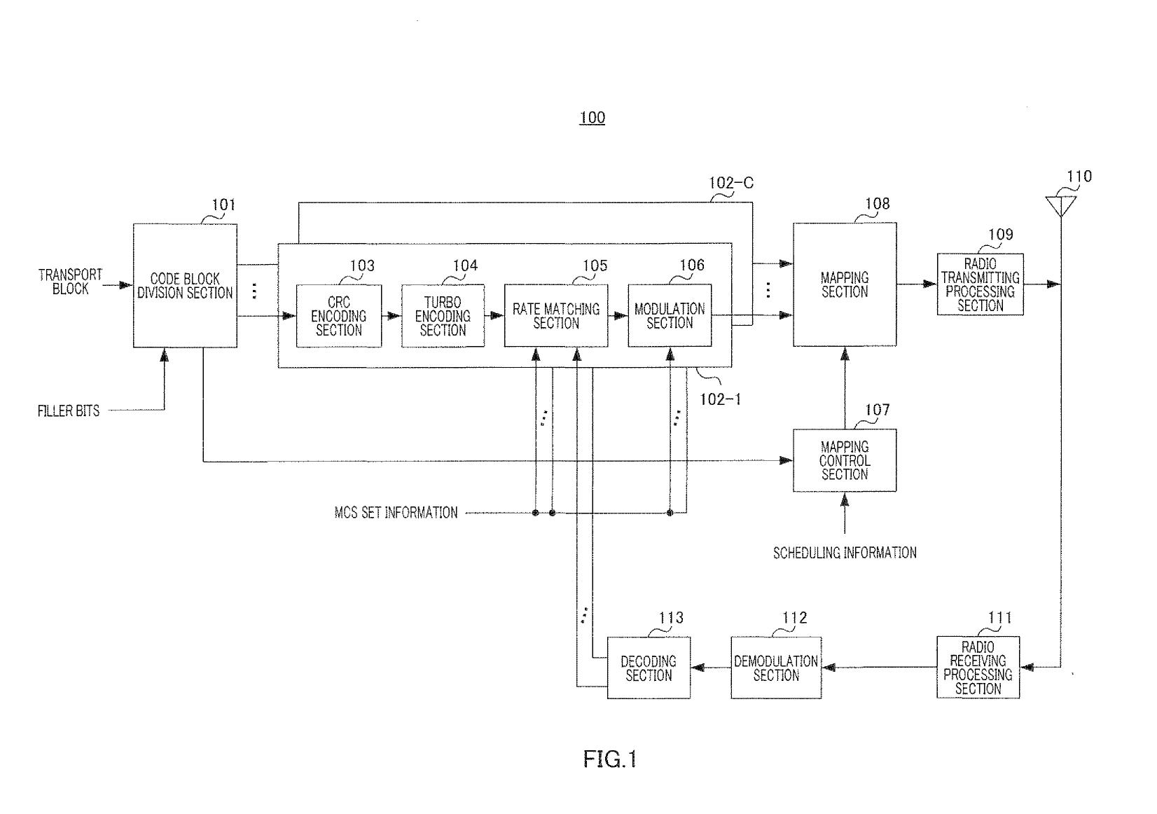

FIG. 1 shows the configuration of transmitting-side radio communication apparatus 100 according to the present embodiment.

In transmitting-side radio communication apparatus 100, code block division section 101 receives as input a transport block from higher layer. Then, code block division section 101 divides the transport block into code blocks in units of coding (which are internal interleaver sizes in turbo encoding section 104 (described later)) to acquire a plurality of code blocks. Here, code block division section 101 divides the transport block into a plurality of code blocks by taking into account the size of CRC bits added in CRC encoding sections 103 in code block processing sections 102-1 to 102-C at the next process. Further, when a transport block cannot be divided into a plurality of code blocks of the defined size, code block division section 101 inserts filler bits into the transport block. Then, code block division section 101 divides the transport block in which filler bits are inserted, into a plurality of code blocks. Then, code block division section 101 outputs a plurality of acquired code blocks to CRC encoding sections 103 in code block processing sections 102-1 to 102-C. Further, code block division section 101 outputs the number of filler bits included in each code block to mapping control section 107.

Code block processing sections 102-1 to 102-C each have CRC encoding section 103, turbo encoding section 104, rate matching section 105 and modulation section 106.

CRC encoding section 103 performs CRC encoding on a code block received as input from code block division section 101. CRC encoding section 103 outputs the code block after CRC encoding to turbo encoding section 104.

Turbo encoding section 104 performs turbo encoding on a code block received as input from CRC encoding section 103. Then, turbo encoding section 104 outputs the code block after turbo encoding to rate matching section 105.

Based on the coding rate shown in MCS (Modulation and channel Coding Scheme) set information, rate matching section 105 performs rate matching on the code block received as input from turbo encoding section 104. Then, rate matching section 105 outputs the code block after rate matching to modulation section 106 and stores the code block in only a predetermined time period. Then, when a response signal received as input from decoding section 113 is an ACK signal, rate matching section 105 discards the stored code block. Meanwhile, when a response signal received as input from decoding section 113 is a NACK signal, rate matching section 105 outputs the stored code block to modulation section 106 again. ARQ is applied to code blocks in this way.

Based on the modulation scheme shown in MCS set information, modulation section 106 modulates the code block received as input from rate matching section 105 to generate data symbols. Modulation section 106 outputs the generated data symbols to mapping section 108.

Mapping control section 107 controls the mapping of the data symbols corresponding to each code block to physical channel resources based on scheduling information showing physical channel resources for code block transmission received as input from a scheduler (not shown) and the number of filler bits received as input from code block division section 101. Here, physical channel resources are represented in the time domain and in the frequency domain. Then, mapping control section 107 outputs mapping information showing the result of mapping data symbols corresponding to each code block, to physical channel resources to mapping section 108. The mapping control processing in mapping control section 107 will be described later in detail.

Based on the mapping information received as input from mapping control section 107, mapping section 108 maps the data symbols received as input from each modulation section 106 in code block processing sections 102-1 to 102-C to physical channel resources. Then, mapping section 108 outputs the data symbols mapped to physical channel resources to radio transmitting processing section 109. The mapping processing in mapping section 108 will be described later in detail.

Radio transmitting processing section 109 performs transmission processing such as D/A conversion, amplification and up-conversion on the data symbols, and transmits the signal after transmission processing to the receiving-side radio communication apparatus.

Meanwhile, radio receiving processing section 111 receives a control signal transmitted from a receiving-side radio communication apparatus via antenna 110, and performs receiving processing including down-conversion and A/D conversion, on that control signal, and outputs the control signal after receiving processing to demodulation section 112. This control signal includes a response signal reported from the receiving-side radio communication apparatus.

Demodulation section 112 demodulates the control signal and outputs the demodulated control signal to decoding section 113.

Decoding section 113 decodes the control signal and outputs a response signal (an ACK signal or NACK signal) included in the control signal, to rate matching sections 105 in code block processing sections 102-1 to 102-C.

Now, the mapping control processing in mapping control section 107 and the mapping processing in mapping section 108 will be described in detail.

A receiving-side radio communication apparatus decodes a received signal using log likelihood ratios (LLRs) of received bits. Here, filler bits are known between both the transmitting-side radio communication apparatus and the receiving-side radio communication apparatus, and therefore, the LLRs of filler bits are higher than the LLRs of other bits, and therefore are the highest LLRs. Accordingly, a code block including filler bits performs decoding better than a code block without filler bits in a receiving-side radio communication apparatus. Accordingly, with a code block in which filler bits are inserted, those high LLRs of filler bits can be used to decode, so that decoding performance, that is, error rate performance improves. That is, among a plurality of code blocks, a difference is produced between error rate performance on the code blocks in which filler bits are inserted and error rate performance on the code blocks in which filler bits are not inserted. That is, the error rate performance of the code blocks in which filler bits are inserted is better than that of the code blocks in which filler bits are not inserted.

Further, among the code blocks in which filler bits are inserted, the code blocks with the larger number of filler bits can use the larger number of higher LLRs for decoding, so that error rate performance improves further. In other words, the code blocks with the smaller number of filler bits make error rate performance poorer.

Then, with the present embodiment, a plurality of code blocks are mapped in order from the code block with the smallest number of filler bits, in order from the head of physical channel resources.

Now, a detailed explanation will be provided below. Here, a transport block is divided into four code blocks (code blocks #0 to #3) and CRC bits are added to each code block. Further, among code blocks #0 to #3, filler bits are inserted in code blocks #2 and #3. Further, the number of filler bits in code block #3 is larger than the number of filler bits in code block #2.

Mapping control section 107 controls a plurality of code blocks such that code blocks are mapped in order from the code block with the smallest number of filler bits, in order from the head of physical channel resources. Specifically, mapping control section 107 extracts code blocks #0 to #3 in order from the code block with the smallest number of filler bits. That is, mapping control section 107 compares the number of filler bits in code block #0, the number of filler bits in code block #1, the number of filler bits in code block #2 and the number of filler bits in code block #3. Accordingly, mapping control section 107 extracts the code blocks to map in order from the head of physical resource block, in order of code block #0 and code block #1, in which the number of filler bits is zero, code block #2, in which the number of filler bits is smaller than in code block #3, and code block #3 with the largest number of filler bits.

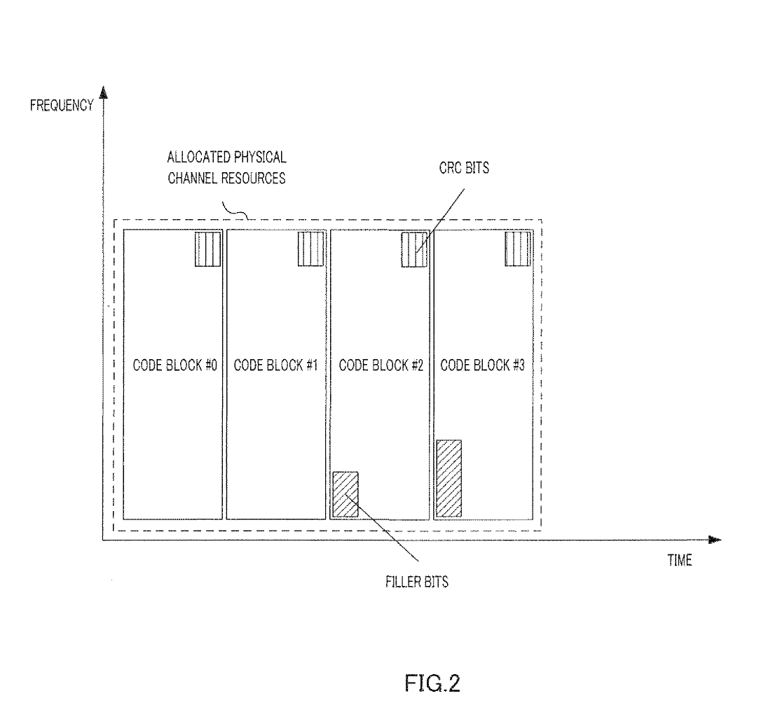

Accordingly, as shown in FIG. 2, mapping section 108 maps code blocks #0 to #3 in order of code block #0, code block #1, code block #2 and code block #3, from the head of physical channel resources that can be used for code blocks.

That is, in code blocks #0 to #3 shown in FIG. 2, the error rate performances of code blocks #0 and #1 in which filler bits are not inserted are poorer than those of code blocks #2 and #3 in which filler bits are inserted. Further, the number of filler bits in code block #2 is smaller than the number of filler bits in code block #3, and therefore, the error rate performance of code block #2 is poorer than that of code block #3.

That is, among a plurality of code blocks, mapping section 108 maps code blocks in order from the code block showing the poorest error rate performance, that is, in order from a code block that is more likely to include errors, in order from the head of the physical channel resources.

A receiving-side radio communication apparatus receives a received signal with the same physical channel resource format as the physical channel resource format shown in FIG. 2. Then, the receiving-side radio communication apparatus demodulates and decodes the code blocks in order from the received code block. Accordingly, the receiving-side radio communication apparatus performs receiving processing, demodulating processing and decoding processing in order of code block #0, code block #1, code block #2 and code block #3, as shown in FIG. 2.

By this means, the receiving-side radio communication apparatus decodes code blocks in order from the code block with the smallest number of filler bits, that is, in order from the code block that is more likely to include errors. Accordingly, in the receiving-side radio communication apparatus, the code blocks in the earlier order of decoding are likely to include error bits. Consequently, in the receiving-side radio communication apparatus, transport block with errors is detected with increased reliability by a smaller number of decoding trials.

In this way, according to the present embodiment, code blocks are transmitted in order from the code block with the smallest number of filler bits, that is, in order from the code block that is more likely to include errors. Accordingly, the receiving-side radio communication apparatus is able to detect an error with priority from a coding block that is likely to include errors, so that it is possible to improve the detection of error bits by a smaller number of decoding trials. By this means, by stopping decoding processing on other code blocks when an error bit is detected, useless decoding processing can be prevented, so that it is possible to reduce the number of times of decoding trial. Therefore, according to the present embodiment, it is possible to reduce power consumption in decoding processing.

Further, according to the present embodiment, bit errors are detected by a smaller number of decoding trials, so that it is possible to reduce the time required for error detection. By this means, by shortening the time required to feed back a response signal from the receiving-side radio communication apparatus to the transmitting-side radio communication apparatus, it is possible to reduce the retransmission delay.

Although a case has been explained with the present embodiment as shown in FIG. 2 where filler bits are transmitted, the present invention is applicable to the cases where filler bits are not transmitted. For example, a transmitting-side radio communication apparatus controls the mapping of code blocks as in the present embodiment, and then deletes filler bits before transmission. Meanwhile, the receiving-side radio communication apparatus sets up the same LLRs as the filler bits at the bit positions corresponding to the filler bits in the received signal. By this means, even when filler bits are not transmitted, the same advantage can be provided as in the present embodiment.

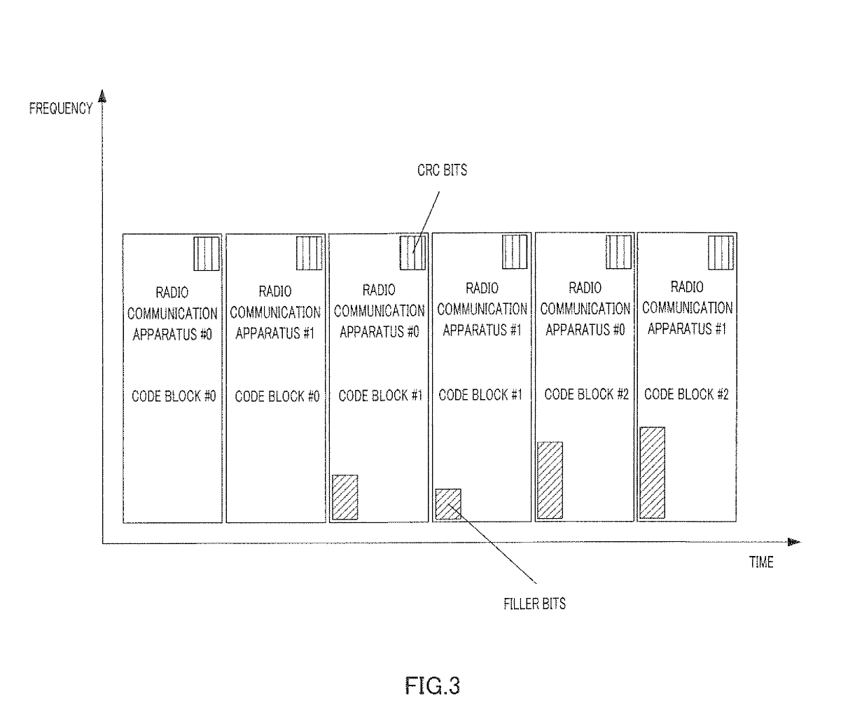

Further, although a case has been explained with the present embodiment about the code block mapping method of one transmitting-side radio communication apparatus, the present invention may be applicable to a plurality of transmitting-side radio communication apparatuses. For example, first, the code blocks of transmitting-side radio communication apparatuses are extracted in order from the code block with the smallest number of filler bits as explained above. Then, as shown in FIG. 3, the code blocks of the transmitting-side radio communication apparatuses are mapped in distributed TDM (Time Division Multiplexing). Here, transmitting-side radio communication apparatuses #0 and #1 each transmit three code blocks #0 to #2. Further, among the code blocks in the transmitting-side radio communication apparatuses, filler bits are inserted in code blocks #1 and code blocks #2, and the number of filler bits in code blocks #2 is larger than the number of filler bits in code blocks #1. As shown in FIG. 3, code blocks #1 and code blocks #2 in which filler bits are inserted, of the two transmitting-side radio communication apparatuses, are mapped to the rear of physical channel resources. Meanwhile, two code blocks #0, in which filler bits are not inserted, that is, in which errors are likely to occur, of the two transmitting-side radio communication apparatuses, are mapped to the head of physical channel resources in a concentrated manner. By this means, with the receiving-side radio communication apparatus, bit errors are detected with increased reliability by a smaller number of decoding trials for all code blocks from transmitting-side radio communication apparatuses. Accordingly, even when the present invention is applied to a plurality of transmitting-side radio communication apparatuses, the same advantage can be provided as in the present embodiment.

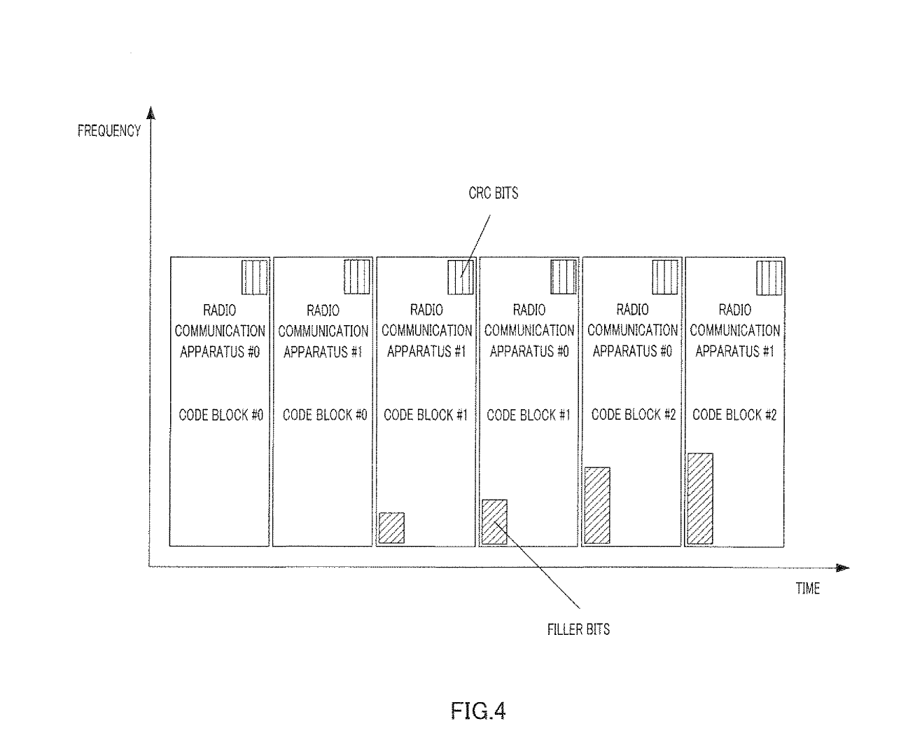

Further, although a case has been explained with the mapping example shown in FIG. 3, where code blocks are extracted in order from the code block with the smallest number of filler bits per transmitting-side radio communication apparatus and where code blocks of different transmitting-side radio communication apparatuses are mapped in distributed TDM, the present invention may be applicable to a plurality of code blocks of all transmitting-side radio communication apparatuses in mobile communication systems. For example, as shown in FIG. 4, total six code blocks of code blocks #0 to #2 of radio communication apparatus #0 and code blocks #0 to #2 of radio communication apparatus #1 are mapped in order from the code block with the smallest number of filler bits, in order from the head of physical channel resources. By this means, code blocks that are more likely to include errors are mapped over all code blocks of transmitting-side radio communication apparatuses in order from the head of physical channel resources. Consequently, bit errors are detected with increased reliability by a smaller number of decoding trials than in the mapping example shown in FIG. 3.

Further, with the present embodiment, in the example of mapping code blocks of a plurality of transmitting-side radio communication apparatuses shown in FIG. 3, distributed TDM mapping may be performed based on round trip time (RTT), which is the time from the time the transmitting-side radio communication apparatus transmits transmission data to the receiving-side radio communication apparatus, to the time the receiving-side radio communication apparatus feeds back a response signal to the transmitting-side radio communication apparatus. For example, code blocks may be mapped to the head of physical channel resource blocks with priority in order from the code block of a transmitting-side radio communication apparatus with the longest RTT. By this means, the effect of reducing the retransmission delay is provided with priority to the transmitting-side radio communication apparatus of longer RTTs, so that it is equally possible to reduce the retransmission delay in the entire mobile communication system.

### Embodiment 2

With the present embodiment, a case where there are a plurality of code blocks of different code block sizes will be explained.

The number of LLRs that can be used upon decoding processing varies between code blocks of different code block sizes. That is, when the code blocks have a larger code block size, it is possible to perform decoding processing using LLRs of more bits. Accordingly, the code blocks of larger code block size further improve decoding performance, that is, error rate performance. In other words, the code blocks of smaller code block size make error rate performance poorer.

That is, when there are a plurality of code blocks of different code block sizes, due to the code block size and the number of filler bits explained in Embodiment 1, a difference is produced between decoding performance on code blocks. Even when there are a plurality of code blocks of different code block sizes, the decoding performance hardly differs if there is virtually no difference in the code block size between code blocks. In this case, the influence of the number of filler bits on decoding performance becomes greater than the influence of the code block size on decoding performance.

Then, with the present embodiment, depending on whether or not the difference in the code block size between a plurality of code blocks is equal to or more than a threshold value, a plurality of code blocks are mapped in order from the head of physical channel resources, in order from the code block showing the poorest error rate performance, that is, in order from the code block of the smallest code block size, or in order from the code block with the smallest number of filler bits.

Code block division section 101 (FIG. 1) in transmitting-side radio communication apparatus 100 according to the present embodiment outputs the number of filler bits and the code block size in each code block to mapping control section 107.

Based on the number of filler bits and the code block size in each code block received as input from code block division section 101, mapping control section 107 controls the mapping of data symbols corresponding to each code block received as input from code block processing sections 102-1 to 102-C, to physical channel resources. Specifically, when the difference in the code block size between a plurality of code blocks is equal to or more than a threshold value, mapping control section 107 controls a plurality of code blocks of different block sizes such that a plurality of code blocks of different block sizes are mapped in order from the code block of the smallest code block size, and in order from the code block with the smallest number of filler bits when there are a plurality of code blocks of the same block size. On the other hand, when the difference in the code block size between a plurality of code blocks is less than the threshold value, mapping control section 107 controls a plurality of code blocks of different block sizes such that a plurality of code blocks of different block sizes are mapped in order from the code block with the smallest number of filler bits, and in order from the code block of the smallest code block size when there are a plurality of code blocks of the same number of filler bits.

Now, a detailed explanation will be provided below. Here, a transport block is divided into four code blocks #0 to #3 as in Embodiment 1. Further, code blocks #0 and #1 have the same code block size, and code blocks #2 and #3 have the same code block size. Further, the code block size of code block #0 (code block #1) is smaller than the code block size of code block #2 (code block #3). Further, among code blocks #0 to #3, filler bits are inserted in code block #1 and code block #3. Here, the same coding rate is used in all code blocks. That is, the number of physical channel resources allocated to code blocks varies between a plurality of code blocks of different code block sizes.

First, a case where the difference between the code block size of code block #0 (code block #1) and the code block size of code block #2 (code block #3) is equal to or more than a threshold value, will be explained.

Specifically, mapping control section 107 extracts code blocks #0 to #3 of different code block sizes in order from the code block of the smallest code block size. That is, mapping control section 107 extracts code blocks #0 and #1 of the smaller code block size among code blocks #0 to #3.

Here, code blocks #0 and #1 have the same code block size. Then, mapping control section 107 further extracts code blocks #0 and #1 in order from the code block with the smaller number of filler bits. That is, mapping control section 107 extracts code blocks in order of code block #0, in which filler bits are not inserted, and code block #1, in which filler bits are inserted. Likewise, mapping control section 107 extracts code blocks in order of code block #2 and code block #3.

That is, the order of code blocks that are mapped in order from the head of physical channel resource blocks is, code block #0, code block #1, code block #2 and code block #3.

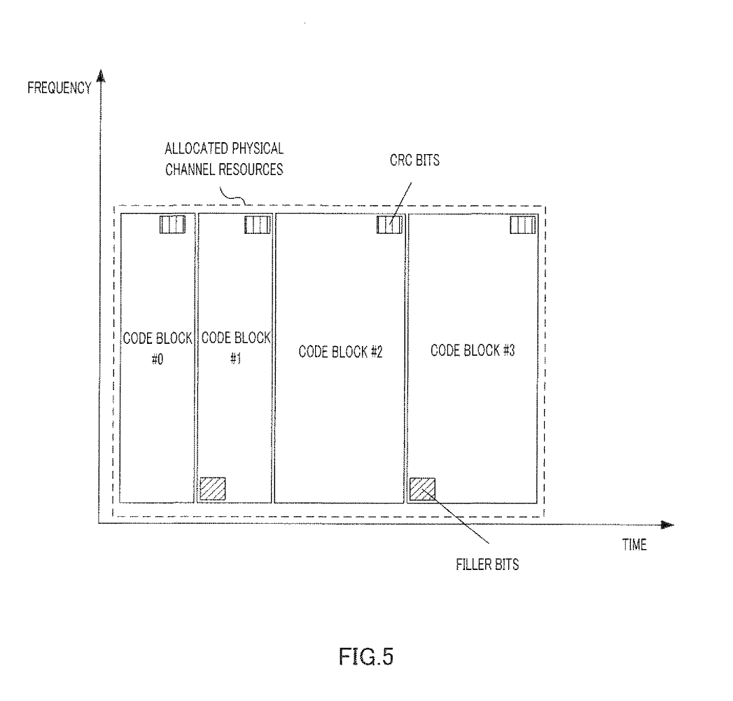

As shown in FIG. 5, mapping section 108 maps the code blocks in order of code block #0, code block #1, code block #2 and code block #3, in order from the head of physical channel resource blocks that can be used for code blocks.

By this means, the receiving-side radio communication apparatus is able to receive a plurality of code blocks in order preferentially reflecting the influence on decoding performance by differences between code block sizes. That is, the receiving-side radio communication apparatus is able to decode code blocks in order from the code block of the smallest code block size, that is, in order from the code block showing the poorest error rate performance. Further, even when there are a plurality of code blocks of the same code block size, the receiving-side radio communication apparatus is able to decode code blocks in order from the code block with the smallest number of filler bits as in Embodiment 1. Accordingly, a plurality of code blocks of the same code block size are ordered in more detail based on the influence of the number of filler bits on decoding performance. Therefore, it is possible to further reduce the number of times of decoding trial.

Next, a case where the difference between the code block size of code block #0 (code block #1) and the code block size of code block #2 (code block #3) is less than the threshold value will be explained.

Mapping control section 107 extracts code blocks #0 to #3 of different code block sizes in order from the code block with the smallest number of filler bits as in Embodiment 1. That is, mapping control section 107 extracts code blocks #0 and #2 in which filler bits are not inserted, from code blocks #0 to #3.

Here, the number of filler bits in code blocks #0 and #2 is zero and the same. Then, mapping control section 107 further extracts code blocks #0 and #2 in order from the code block of the smaller code block size. That is, mapping control section 107 extracts code blocks in order of code block #0 in which the code block size is the smaller and code block #2 in which the code block size is the larger. Likewise, mapping control section 107 extracts code blocks in order of code block #1 and code block #3.

That is, the order of code blocks mapped in order from the head of physical channel resource blocks is, code block #0, code block #2, code block #1 and code block #3.

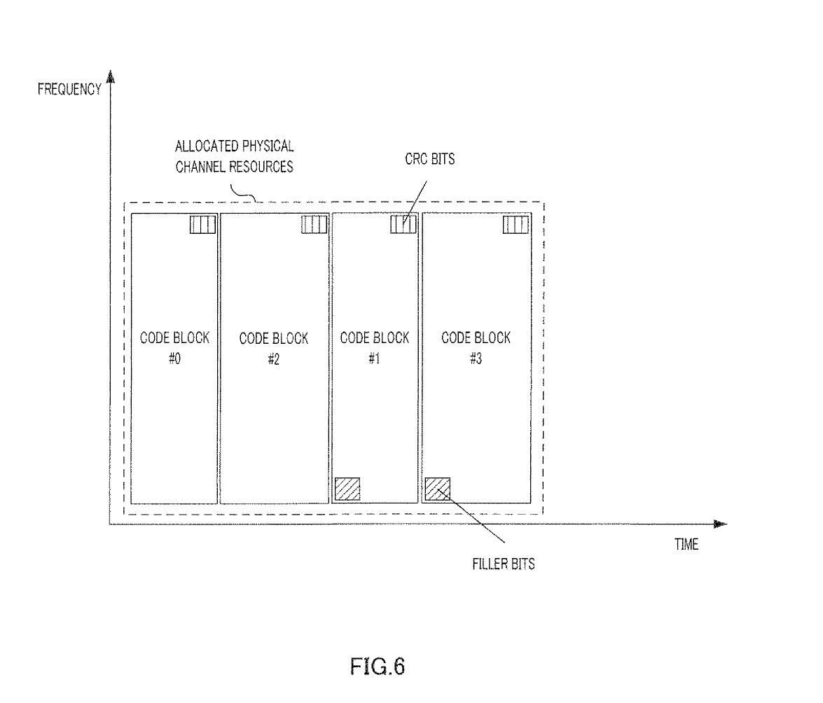

As shown in FIG. 6, mapping section 108 maps the code blocks to physical channel resource blocks that can be used for code blocks from the head, in order of code block #0, code block #2, code block #1 and code block #3.

By this means, as in Embodiment 1, the receiving-side radio communication apparatus is able to receive a plurality of code blocks in the order preferentially reflecting the influence on decoding performance by differences between the numbers of filler bits. Further, even when there are a plurality of code blocks of the same number of filler bits, the receiving-side radio communication apparatus is able to decode code blocks in order from the code block of the smallest code block size. Accordingly, a plurality of code blocks of the same number of filler bits arc ordered in more detail based on the influence of the code block size on decoding performance. Therefore, it is possible to reduce the number of times of decoding trial.

In this way, according to the present embodiment, one of the influence on decoding performance by the differences between code block sizes and the influence on decoding performance by the differences between the numbers of filler bits, having the greater influence on decoding performance, is reflected with priority to map code blocks to physical channel resources. Further, even when there are a plurality of code blocks between which the difference of the greater influence on decoding performance of the difference between code block sizes and the difference between the numbers of filler bits in a plurality of code blocks is the same, code blocks are mapped to physical channel resources based on the difference of the less influence on decoding performance. By this means, in the transmitting-side radio communication apparatus, it is possible to map code blocks to physical channel resources more precisely than in Embodiment 1, in order from the code block showing the poorest decoding performance. Therefore, according to the present embodiment, when there are a plurality of code blocks of different code block sizes, bit errors are detected with increased reliability by a smaller number of decoding trials than in Embodiment 1, so that it is possible to reduce power consumption in decoding processing.

Further, according to the present embodiment, when there are a plurality of code blocks of different code block sizes, bit errors are detected with increased reliability by a smaller number of decoding trials than in Embodiment 1, so that it is equally possible to reduce the time required for error detection.

Therefore, according to the present embodiment, even when there are a plurality of transmitting-side radio communication apparatuses, by mapping code blocks of different transmitting-side radio communication apparatuses in distributed TDM as in Embodiment 1, it is equally possible to reduce the retransmission delay in the entire mobile communication system.

### Embodiment 3

With the present embodiment, a case where there are a plurality of code blocks having different coding rates will be explained.

When number of physical channel resources allocated to each code block is the same, in code blocks having different coding rates, the composition ratio between the numbers of systematic bits and the number of parity bits after turbo encoding varies. Specifically, when the coding rate of a code block is lower, the number of systematic bits decreases and the number of parity bits increases. That is, it is possible to perform decoding processing using more parity bits for a code block having a lower coding rate. Accordingly, a code block having a lower coding rate further improves decoding performance, that is, error rate performance. In other words, the code block having a higher coding rate makes error rate performance poorer.

That is, when there are a plurality of code blocks having different coding rates, due to the coding rates and the number of filler bits explained in Embodiment 1, a difference is produced between decoding performance on the code blocks. When there is virtually no difference between code blocks having different coding rates, as in Embodiment 2, the influence on decoding performance by the number of filler bits becomes greater than the influence of the coding rate on decoding performance.

Then, with the present embodiment, depending on whether or not the difference in the coding rate between a plurality of code blocks is equal to or more than a threshold value, a plurality of code blocks are mapped in order from the code block showing the poorest error rate performance, that is, in order from the code block of the highest coding rate, or in order from the code block with the smallest number of filler bits, in order from the head of physical channel resources.

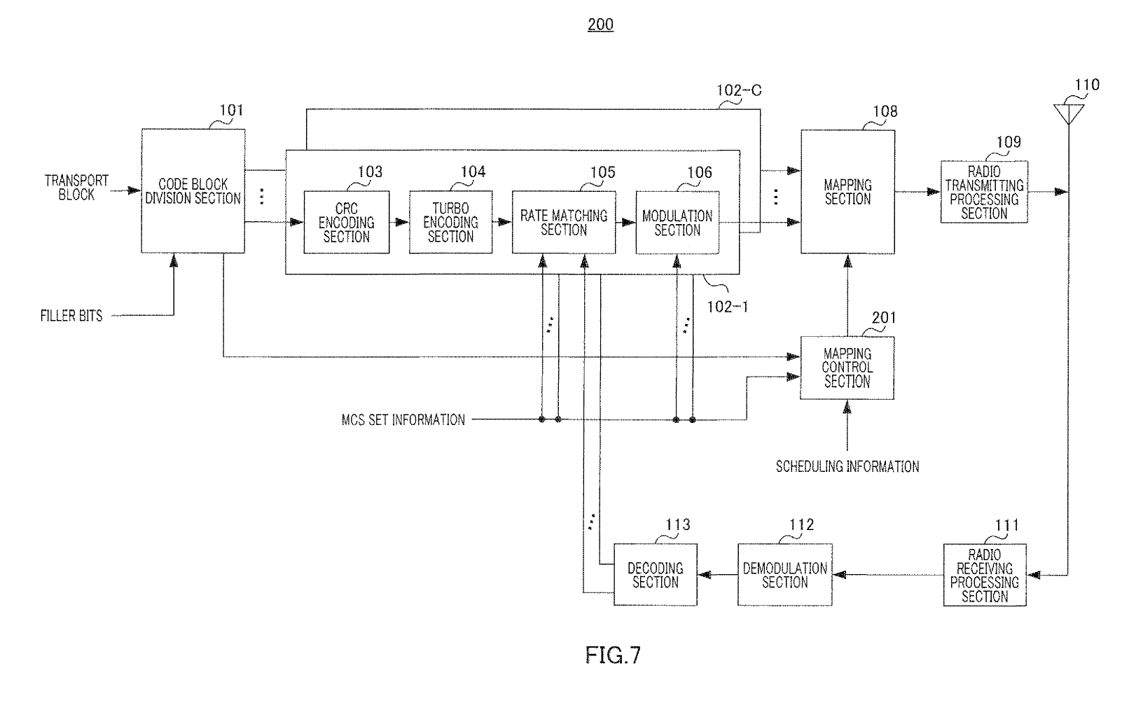

FIG. 7 shows the configuration of transmitting-side radio communication apparatus 200 according to the present embodiment. Mapping control section 201 receives as input the number of filler bits and the code block size from code block division section 101, and MCS set information.

Based on the coding rates for code blocks, mapping control section 201 controls the mapping of data symbols corresponding to each code block received as input from code block processing sections 102-1 to 102-C, to physical channel resources. Here, the coding rate for a code block is derived from the code block size/(the number of physical channel resources×the M-ary modulation order shown in MCS set information). Specifically, when the difference in the coding rate between a plurality of code blocks is equal to or more than a threshold value, mapping control section 201 controls a plurality of code blocks having different coding rates such that a plurality of code blocks having different coding rates are mapped in order from the code block having the highest coding rate, and in order from the code block with the smallest number of filler bits when there are a plurality of code blocks having the same coding rate. On the other hand, when the difference in the coding rate between a plurality of code blocks is less than the threshold value, mapping control section 201 controls a plurality of code blocks having different coding rates such that a plurality of code blocks having different coding rates are mapped in order from the code block with the smallest number of filler bits, and in order from the code block having the highest coding rate when there are a plurality of code blocks of the same number of filler bits.

Now, a detailed explanation will be provided below. Here, a transport block is divided into four code blocks #0 to #3 as in Embodiment 1. Further, coding rate R₀ for code block #0 and coding rate R₁ for code block #1 have the same coding rate, and coding rate R₂ for code block #2 and coding rate R₃ for code block #3 have the same coding rate. Further, coding rate R₀ (coding rate R₁) is higher than coding rate R₂ (coding rate R₃). Further, among code blocks #0 to #3, filler bits are inserted in code block #1 and code block #3. Further, the number of physical channel resources allocated to each code block is the same. Here, the same numbers of physical channel resources, that is, four physical channel resource blocks #0 to #3, are used for code blocks.

First, a case where the difference between the coding rate for code block #0 (code block #1) and the coding rate for code block #2 (code block #3) is equal to or more than a threshold value (R₀(=R₁)−R₂(=R₃)≧threshold value, will be explained.

Specifically, mapping control section 201 extracts code blocks #0 to #3 having different coding rates in order from the code block having the highest coding rate. That is, mapping control section 201 extracts code blocks #0 and #1 having higher coding rates among code blocks #0 to #3.

Here, code blocks #0 and #1 have the same coding rate. Then, mapping control section 201 further extracts code blocks #0 and #1 in order from the code block with the smaller number of filler bits. That is, mapping control section 201 extracts code blocks in order of code block #0, in which filler bits are not inserted, and code block #1, in which filler bits are inserted. Likewise, mapping control section 201 extracts code blocks in order of code block #2 and code block #3.

That is, the order of code blocks that are mapped in order from the head of physical channel resource blocks is, code block #0, code block #1, code block #2 and code block #3.

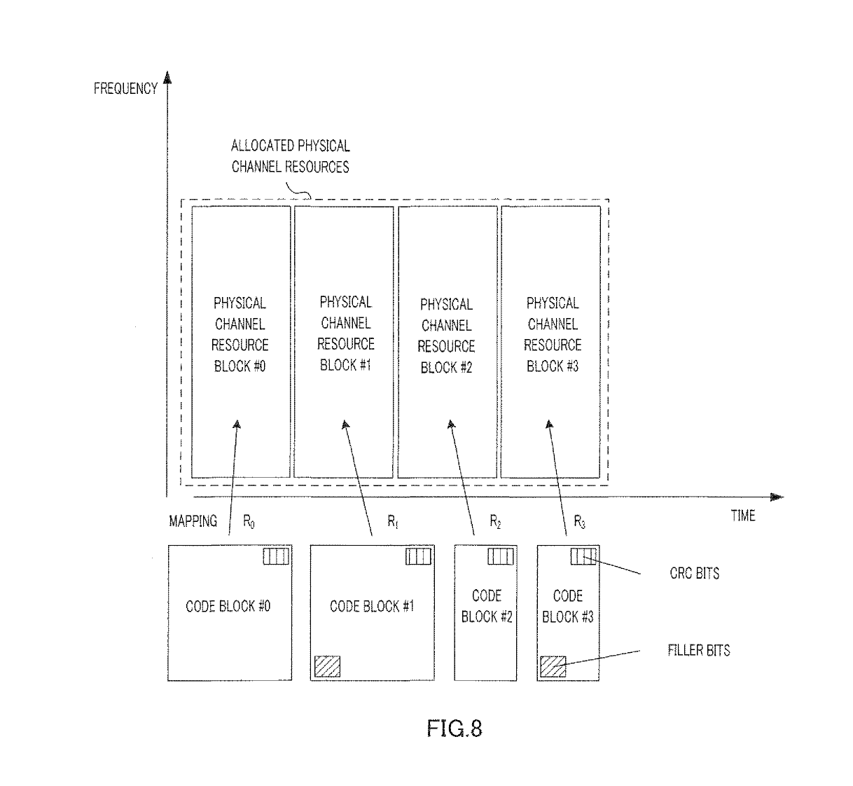

Then, mapping section 108 maps the code blocks in order of code block #0, code block #1, code block #2 and code block #3 from the head of physical channel resource blocks that can be used for code blocks. Accordingly, as shown in FIG. 8, mapping section 108 maps code block #0 to physical channel resource block #0, maps code block #1 to physical channel resource block #1, maps code block #2 to physical channel resource block. #2, and maps code block #3 to physical channel resource block #3.

By this means, the receiving-side radio communication apparatus is able to receive a plurality of code blocks in order preferentially reflecting the influence on decoding performance by differences between coding rates. That is, the receiving-side radio communication apparatus is able to decode code blocks in order from the code block having the highest coding rate, that is, in order from the code block showing the poorest error rate performance. Further, even when there are a plurality of code blocks having the same coding rate, it is possible to decode code blocks in order from the code block with the smallest number of filler bits as in Embodiment 1. Accordingly, a plurality of code blocks having the same coding rate are ordered in more detail based on the influence of the number of filler bits on decoding performance. Therefore, it is possible to further reduce the number of times of decoding trial.

Next, a case where the difference between the coding rate for code block #0 (code block #1) and the coding rate for code block #2 (code block #3) is less than a threshold value (R₀(=R₁)-R₂(=R₃)<threshold value), will be explained.

Mapping control section 201 extracts code blocks #0 to #3 having different coding rates in order from the code block with the smallest number of filler bits as in Embodiment 1. That is, mapping control section 201 extracts code blocks #0 and #2 in which filler bits are not inserted, from code blocks #0 to #3.

Here, the number of filler bits in code blocks #0 and #2 is zero and the same. Then, mapping control section 201 further extracts code blocks #0 and #2 in order from the code block having the higher coding rate. That is, mapping control section 201 extracts code blocks in order of code block #0 having the higher coding rate and code block #2 having the lower coding rate. Likewise, mapping control section 201 extracts code blocks in order of code block #1 and code block #3.

That is, the order of code blocks that are mapped in order from the head of physical channel resource blocks is, code block #0, code block #2, code block #1 and code block #3.

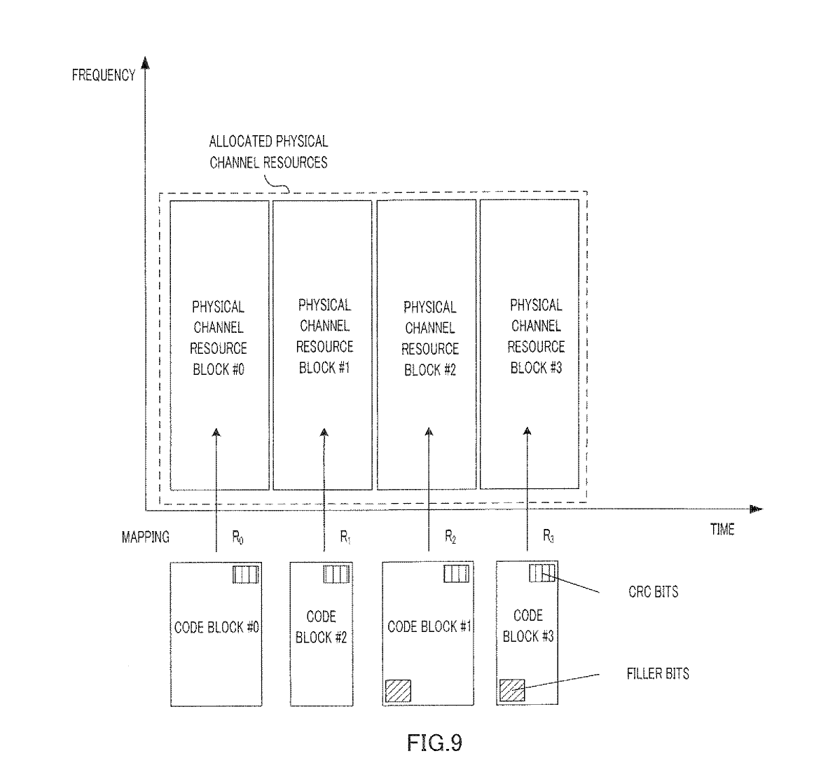

Then, mapping section 108 maps the code blocks in order from the head of physical channel resource blocks that can be used for code blocks, in order of code block #0, code block #2, code block #1 and code block #3. Accordingly, as shown in FIG. 9, mapping section 108 maps code block #0 to physical channel resource block #0, maps code block #2 to physical channel resource block #1, maps code block #1 to physical channel resource block #2, and maps code block #3 to physical channel resource block #3.

By this means, as in Embodiment 1, the receiving-side radio communication apparatus is able to receive a plurality of code blocks in order preferentially reflecting the influence on decoding performance by the difference between the numbers of filler bits. Further, even when there are a plurality of code blocks of the same number of filler bits, the receiving-side radio communication apparatus is able to decode code blocks in order from the code block having the highest coding rate. Accordingly, a plurality of code blocks of the same number of filler bits are ordered in more detail based on the influence of the coding rate on decoding performance. Therefore, it is possible to reduce the number of times of decoding trial.

In this way, according to the present embodiment, one of the influence on decoding performance by the differences between coding rates and the influence on decoding performance by the differences between the numbers of filler bits, having the greater influence on decoding performance, is reflected with priority to map code blocks to physical channel resource blocks. Accordingly, even when there are a plurality of code blocks having different coding rates, the same advantage can be provided as in Embodiment 2.

Therefore, according to the present embodiment, even when there are a plurality of transmitting-side radio communication apparatuses, by mapping code blocks of different transmitting-side radio communication apparatuses in distributed TDM as in Embodiment 1, it is equally possible to reduce the retransmission delay in the entire mobile communication system.

### Embodiment 4

With the present embodiment, a case where there are a plurality of code blocks to which different frequency bandwidths are allocated will be explained.

Frequency diversity effect vary between code blocks to which different frequency bandwidths are allocated. Specifically, the frequency diversity effect becomes more significant when a wider frequency bandwidth is allocated to a code block. Accordingly, a wider frequency bandwidth allocated to a code block further improves decoding performance, that is, error rate performance. In other words, when a narrower frequency bandwidth is allocated to a code block, error rate performance becomes poorer.

That is, when there are a plurality of code blocks to which physical channel resource of different bandwidths are allocated, due to frequency bandwidths allocated to the code blocks and the number of filler bits explained in Embodiment 1, a difference is produced between decoding performance on the code blocks. When there is virtually no difference between the different frequency bandwidths of code blocks, as in Embodiment 2, the influence of the number of filler bits on decoding performance becomes greater than the influence of the frequency bandwidths on decoding performance.

Then, with the present embodiment, depending on whether or not the difference in the frequency bandwidth between a plurality of code blocks is equal to or more than a threshold value, a plurality of code blocks are mapped to physical channel resources in order from the head of physical channel resources, in order from the code block showing the poorest error rate performance, that is, in order from the code block to which the narrowest frequency bandwidth is allocated, or in order from the code block with the smallest number of filler bits.

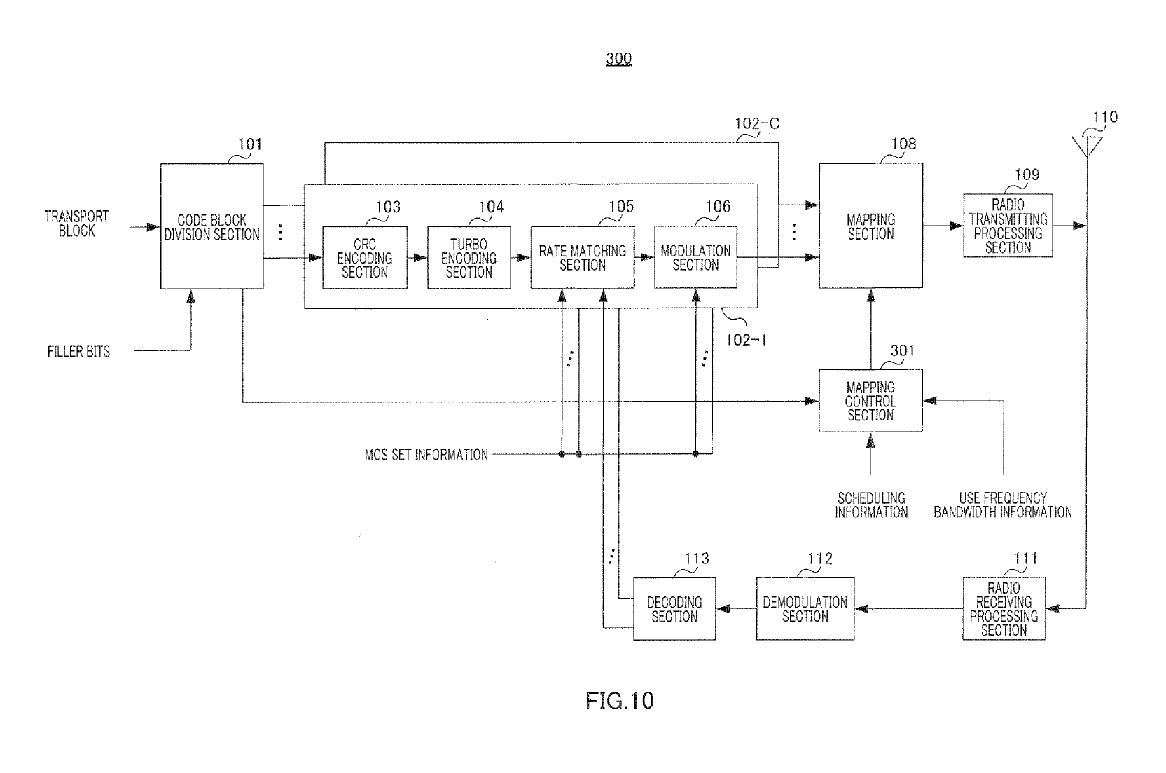

FIG. 10 shows the configuration of the transmitting-side radio communication apparatus 300 according to the present embodiment. Mapping control section 301 receives as input the number of filler bits from code block division section 101 and frequency bandwidth information about physical channel resources allocated to code blocks. Based on the number of filler bits and frequency bandwidths, mapping control section 301 controls the mapping of data symbols corresponding to each code block received as input from code block processing sections 102-1 to 102-C, to physical channel resources. Specifically, when the difference in the frequency bandwidth between a plurality of code blocks is equal to or more than a threshold value, mapping control section 301 controls a plurality of code blocks to which different frequency bandwidths are allocated such that the code blocks are mapped in order from the code block to which the narrowest frequency bandwidth is allocated, and in order from the code block with the smallest number of filler bits when there are a plurality of code blocks to which the same frequency bandwidth is allocated. On the other hand, when the difference in the frequency bandwidth between a plurality of code blocks is less than the threshold value, mapping control section 301 controls a plurality of code blocks to which different frequency bandwidths are allocated such that the code blocks are mapped in order from the code block with the smallest number of filler bits, and in order from the code block to which the narrowest frequency bandwidth is allocated when there are a plurality of code blocks of the same number of filler bits.

Now, a detailed explanation will be provided below. Here, a transport block is divided into four code blocks #0 to #3 as in Embodiment 1. Further, code blocks #0 and #1 have the same frequency bandwidth W, and code blocks #2 and #3 have the same frequency bandwidth W′. Further, frequency bandwidth W is narrower than frequency bandwidth W′. Further, among code blocks #0 to #3, filler bits are inserted in code block #1 and code block #3. Further, the same coding rate is used in all code blocks.

First, a case where the difference between frequency bandwidth W of code block #0 (code block #1) and frequency bandwidth W′ of code block #2 (code block #3) is equal to or more than a threshold value (W′-W≧threshold value), will be explained.

Mapping control section 301 extracts code blocks #0 to #3 of different frequency bandwidths in order from the code block to which the narrowest frequency bandwidth is allocated. That is, mapping control section 301 extracts code blocks #0 and #1 of the narrowest frequency bandwidth among code blocks #0 to #3.

Here, the frequency bandwidths of code blocks #0 and #1 are the same, W. Then, mapping control section 301 further extracts code blocks #0 and #1 in order from the code block with the smaller number of filler bits. That is, mapping control section 301 extracts code blocks in order of code block #0, in which filler bits are not inserted, and code block #1, in which filler bits are inserted. Likewise, mapping control section 301 extracts code blocks in order of code block #2 and code block #3.

That is, the order of code blocks that are mapped in order from the head of physical channel resource blocks is, code block #0, code block #1, code block #2 and code block #3.

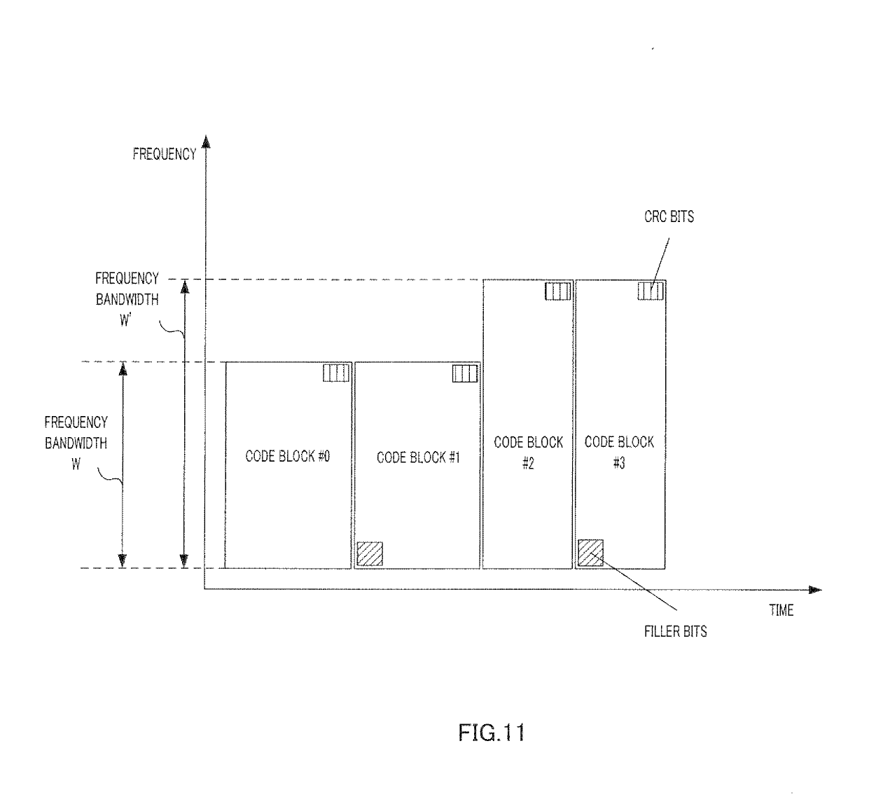

As shown in FIG. 11, mapping section 108 maps the code blocks in order from the head of physical channel resource blocks that can be used for code blocks, in order of code block #0, code block #1, code block #2 and code block #3.

By this means, the receiving-side radio communication apparatus is able to receive a plurality of code blocks in order preferentially reflecting the influence on decoding performance by the difference in frequency diversity effects caused by the differences between frequency bandwidths. That is, the receiving-side radio communication apparatus is able to decode code blocks in order from the code block to which the narrowest frequency bandwidth is allocated, that is, in order from the code block showing the poorest error rate performance. Further, even when there are a plurality of code blocks in the same frequency bandwidths, it is possible to decode code blocks in order from the code block with the smallest number of filler bits as in Embodiment 1. Accordingly, a plurality of code blocks in the same frequency bandwidth are ordered in more detail based on the influence of the number of filler bits on decoding performance. Therefore, it is possible to further reduce the number of times of decoding trial.

Next, a case where the difference between frequency bandwidth W of code block #0 (code block #1) and frequency bandwidth W′ of code block #2 (code block #3) is less than a threshold value (W′−W<threshold value), will be explained.

Mapping control section 301 extracts code blocks #0 to #3 in different frequency bandwidths in order from the code block with the smallest number of filler bits as in Embodiment 1. That is, mapping control section 301 extracts code blocks #0 and #2 in which filler bits are not inserted, in code blocks #0 to #3.

Here, the number of filler bits in code blocks #0 and #2 is the same. Then, mapping control section 301 further extracts code blocks #0 and #2 in order from the code block of the narrower frequency bandwidth. That is, mapping control section 301 extracts code blocks in order of code block #0, in which the frequency bandwidth is the narrower and code block #2, in which the frequency bandwidth is the wider. Likewise, mapping control section 301 extracts code blocks in order of code block #1 and code block #3.

That is, the order of code blocks that are mapped in order from the head of physical channel resource blocks is, code block #0, code block #2, code block #1 and code block #3.

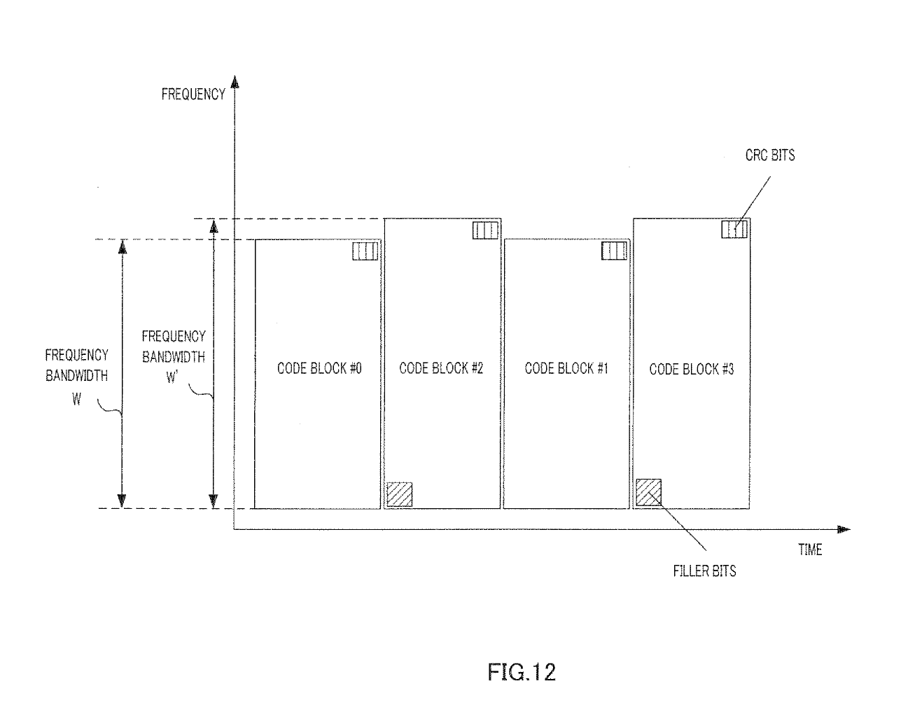

As shown in FIG. 12, mapping section 108 maps the code blocks in order of code block #0, code block #2, code block #1 and code block #3 from the head of physical channel resource blocks that can be used for code blocks.

By this means, the receiving-side radio communication apparatus is able to receive a plurality of code blocks in order preferentially reflecting the influence on decoding performance by the difference between the numbers of filler bits. Further, even when there are a plurality of code blocks of the same number of filler bits, the receiving-side radio communication apparatus is able to decode code blocks in order from the code block in the narrowest frequency bandwidth. Accordingly, a plurality of code blocks of the same number of filler bits are ordered in more detail based on the influence of the allocated frequency bandwidth on decoding performance. Therefore, it is possible to further reduce the number of times of decoding trial.

In this way, according to the present embodiment, one of the influence on decoding performance by the differences between different frequency bandwidths and the influence on decoding performance by the differences between the different numbers of filler bits, having the greater influence on decoding performance, is reflected with priority to map code blocks to physical channel resource blocks. Accordingly, even when there are a plurality of code blocks in different frequency bands, the same advantage can be provided as in Embodiment 2.

Although a case has been explained with the present embodiment, as shown in FIGS. 11 and 12, where code blocks are mapped to physical channel resources in the frequency domain in a localized manner, with the present invention, code blocks are mapped to physical channel resources in the frequency domain in a distributed or scattered manner.

Further, according to the present embodiment, even when there are a plurality of transmitting-side radio communication apparatuses, by mapping code blocks of different transmitting-side radio communication apparatuses in distributed TDM as in Embodiment 1, it is equally possible to reduce the retransmission delay in the entire mobile communication system.

### Embodiment 5

With the present embodiment, a case where MIMO (Multi-Input Multi-Output) transmission is employed will be explained.

In a MIMO transmission technique, which is one of transmission techniques for realizing high speed and high capacity data transmission, by providing a plurality of antennas both on the transmitting side and the receiving side, by preparing a plurality of channels (streams) in space between radio transmission and radio reception and by spatially multiplexing the streams, it is possible to increase throughput. The transmission unit in MIMO transmission is referred to as “codeword.”

When MIMO transmission is employed, a receiving-side radio communication apparatus generates CQIs (Channel Quality Indicators) showing channel quality of streams, and feeds back the CQIs for streams to the transmitting-side radio communication apparatus. For example, the receiving-side radio communication apparatus calculates a CQI based on an average value of SINRs in a predetermined interval. The transmitting-side radio communication apparatus determines MCS set information based on the feedback CQIs.

Here, a stream of good channel quality and having a higher CQI (i.e. SINR of a stream is higher) makes variation of SINR (i.e. variance of SINR) in the time domain smaller. By contrast with this, a stream of poor channel quality and having a lower CQI (i.e. SINR of a stream is lower) makes variance of SINR in the time domain larger.

That is, when CQI for a stream is lower, the difference between an instantaneous value of SINR at a given time and an average SINR in a predetermined time interval becomes larger. Accordingly, the difference between the actual SINR and the average SINR can be larger with a stream of lower CQI, and therefore, the accuracy of CQI calculated based on the average SINR becomes poor. That is, when CQI for a stream is lower, the accuracy of selecting MCS used in the transmitting-side radio communication apparatus upon encoding and modulation of a codeword becomes poorer. Accordingly, decoding performance, that is, error rate performance becomes poor for a codeword mapped to a stream of lower CQI.

Then, with the present embodiment, in a stream in which CQI is less than a predetermined threshold value among a plurality of streams, a plurality of code blocks are mapped in order from the code block with the smallest number of filler bits.

Now, a detailed explanation will be provided below. In the following explanation, a transport block in the above-described embodiments will be referred to as a “codeword.” That is, with the present embodiment, a transmitting-side radio communication apparatus divides a codeword from higher-layer in coding units, to acquire a plurality of code blocks. Here, maximum M codewords #0 to #M-1 is inputted from higher layer.

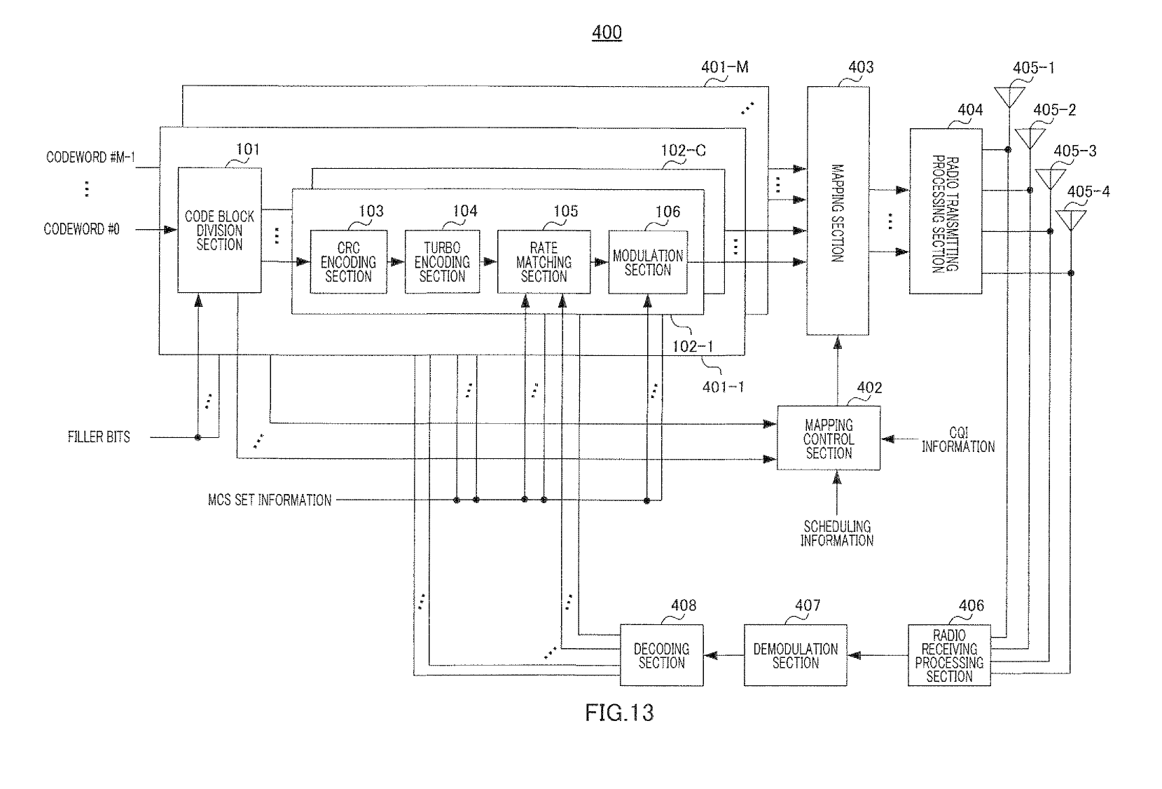

FIG. 13 shows the configuration of transmitting-side radio communication apparatus 400 according to the present embodiment.

In transmitting-side radio communication apparatus 400 shown in FIG. 13, codeword processing sections 401-1 to 401-M formed with code block division section 101 and code block processing sections 102-1 to 102-C are provided in the number of maximum codewords M received as input from higher layer. Specifically, transmitting-side radio communication apparatus 400 has codeword processing sections 401-1 to 401-M corresponding to codewords #0 to #M-1.

Similar to Embodiment 1, codeword processing sections 401-1 to 401-M divide codewords #0 to #M-1 as input, respectively, into a plurality of code blocks in code block division section 101 and generate data symbols corresponding to a plurality of code blocks in code block processing sections 102-1 to 102-C. Then, codeword processing sections 401-1 to 401-M output codewords #0 to #M-1 each composed of a plurality of code blocks to mapping section 403.

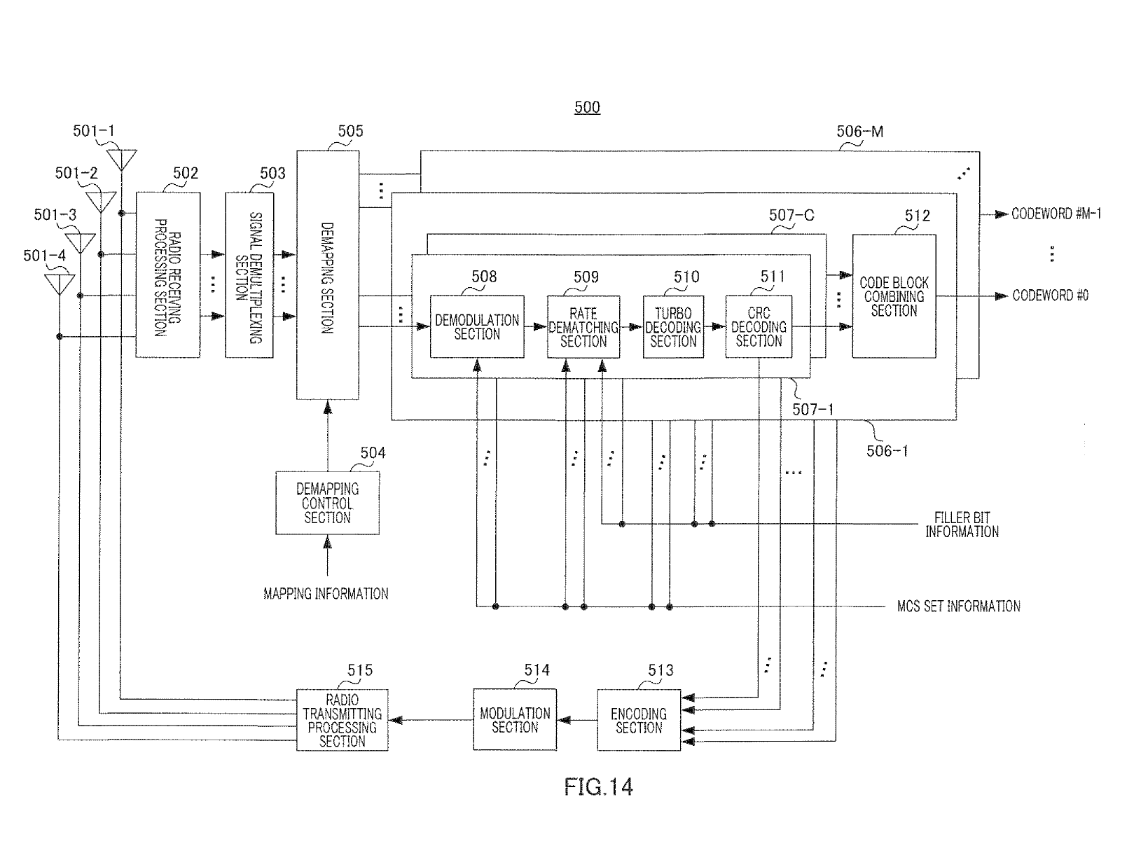

Based on scheduling information, the number of filler bits received as input from code block division sections 101 in codeword processing sections 401-1 to 401-M, and CQI information showing CQIs for streams fed back from receiving-side radio communicating apparatus 500 (FIG. 14), mapping control section 402 controls the mapping of the data symbols corresponding to code blocks to physical channel resources. Here, physical channel resources are represented in the time domain and in streams (the spatial domain). Then, mapping control section 402 outputs mapping information showing the result of mapping data symbols corresponding to each code block to physical channel resources to mapping section 403. Further, the mapping information is transmitted from the transmitting section (not shown) to receiving-side radio communication apparatus 500 (FIG. 14). The mapping control processing in mapping control section 402 will be described later in detail.

Based on the mapping information received as input from mapping control section 402, mapping section 403 maps data symbols received as input from code block processing sections 102-1 to 102-C in codeword processing sections 401-1 to 401-M, to physical channel resources. Then, mapping section 403 outputs the data symbols mapped to physical channel resources to radio transmitting processing section 404. The mapping processing in mapping section 403 will be described later in detail.

Radio transmitting processing section 404 performs transmission processing such as D/A conversion, amplification and up-conversion on the data symbols received as input from mapping section 403, and transmits the signal after transmission processing from antennas 405-1 to 405-M. In this way, a plurality of code blocks are subject to spatial multiplexing transmission from a plurality of antennas using a plurality of streams.

Meanwhile, radio receiving processing section 406 receives a control signal transmitted from receiving-side radio communication apparatus 500 (FIG. 14) via antennas 405-1 to 405-4, and performs receiving processing including down-conversion and A/D conversion, on that control signal, and outputs the control signal after receiving processing to demodulation section 407. This control signal includes a response signal (ACK or NACK signal) reported from receiving-side radio communication apparatus 500.

Demodulation section 407 demodulates the control signal and outputs the demodulated control signal to decoding section 408.

Decoding section 408 decodes the control signal and outputs a response signal included in the control signal, to rate matching sections 105 in code block processing sections 102-1 to 102-C in codeword processing sections 401-1 to 401-M

Next, the receiving-side radio communication apparatus according to the present embodiment will be explained. FIG. 14 shows the configuration of receiving-side radio communication apparatus 500 according to the present embodiment. In the receiving-side radio communication apparatus 500, codeword processing sections 506-1 to 506-M formed with code block processing sections 507-1 to 507-C and code block combining section 512 are provided in the number of maximum codewords M received as input from transmitting radio communication apparatus 400 (FIG. 13). Specifically, receiving-side radio communication apparatus 500 has codeword processing sections 506-1 to 506-M corresponding to codewords #0 to #M-1.

Meanwhile, in receiving-side radio receiving processing section 500 shown in FIG. 14, radio receiving processing section 502 receives signals transmitted from transmitting-side radio communication apparatus 400 (FIG. 13) via antennas 501-1 to 501-4, and performs receiving processing including down-conversion and A/D conversion, on those signals, and outputs the signals after receiving processing to signal demultiplexing section 503.

Signal demultiplexing section 503 demultiplexes the signals received as input from radio receiving processing section 502 to groups of a plurality of streams, and outputs a plurality of demultiplexed streams to demapping section 505. For example, signal demultiplexing section 503 may use linear signal demultiplexing methods including MMSE (Minimum Mean Square Error) and ZF (Zero Forcing) and so on, or non-linear signal demultiplexing methods including SIC (Successive Interference Canceller) and MLD (Maximum Likelihood Detection) and so on.

Based on mapping information received in the receiving section (not shown) from transmitting-side radio communication apparatus 400 (FIG. 13), demapping control section 504 controls the demapping of data symbols corresponding to each code block mapped to physical channel resources. Then, demapping control section 504 outputs demapping information showing the result of demapping data symbols corresponding to code blocks mapped to physical channel resources to demapping section 505.

Based on the demapping information received as input from demapping control section 504, demapping section 505 demaps a plurality of streams received as input from signal demultiplexing section 503, and acquires code blocks (symbol sequences) of a plurality of codewords. Then, demapping section 505 outputs the code blocks (symbol sequences) of a plurality of codewords to codeword processing sections 506-1 to 506-M corresponding to codewords #0 to #M-1, respectively

Code block processing sections 507-1 to 507-C in codeword processing sections 506-1 to 506-M each have demodulation section 508, rate dematching section 509, turbo decoding section 510 and CRC decoding section 511. When retransmission of codewords is controlled every codeword, codeword processing sections 506-1 to 506-M receive varying MCS set information as input. A code block processing section in a codeword processing section receives the same MCS set information as input.

Based on the modulation scheme shown in MCS set information, demodulation section 508 demodulates the code blocks (symbol sequences) received as input from demapping section 505. Specifically, demodulation section 508 calculates LLRs of the code blocks from the code blocks (symbol sequences). Then, demodulation section 508 outputs the calculated code block LLRs to rate dematching section 509.

Based on the coding rate shown in MCS set information, rate dematching section 509 performs rate dematching on the code block LLRs received as input from demodulation section 508. At this time, based on filler bit information showing the number of filler bits in each code block and positions in which filler bits are arranged in each code block, rate dematching section 509 inserts the maximum LLR in the positions filler bits are arranged in each code block. Then, rate dematching section 509 outputs the code blocks after rate dematching to turbo decoding section 510. Filler bit information may be transmitted from transmitting-side radio communication apparatus 400 and may be calculated in receiving-side radio communication apparatus 500 using the size of codewords and so on.

Turbo decoding section 510 performs turbo decoding on the code blocks received as input from rate dematching section 509. Turbo decoding section 510 outputs the code blocks (bit sequences) after turbo decoding to CRC decoding section 511.

CRC decoding section 511 performs CRC decoding on the code blocks received as input from turbo decoding section 510. Then, when an error is not present on all code blocks in the codeword, CRC decoding section 511 outputs an ACK signal to encoding section 513 and outputs the code blocks to code block combining section 512. Meanwhile, when an error is present on the code blocks in the codeword, CRC decoding section 511 outputs a NACK signal to encoding section 513.

Code block combining section 512 combines the code blocks received as input from CRC decoding sections 511 in code block processing sections 507-1 to 507-C, to generate codewords. That is, code block combining sections 512 in codeword processing sections 506-1 to 506-M respectively generate codewords #0 to #M-1, and output the generated codewords #0 to #M-1 to higher layer.

Meanwhile, encoding section 513 encodes a control signal including a response signal (an ACK or NACK signal) received as input from CRC decoding sections 511 in code block processing sections 507-1 to 507-C in codeword processing sections 506-1 to 506-M, and outputs the encoded control signal to modulation section 514.

Modulation section 514 modulates the control signal received as input from encoding section 513, and outputs the modulated control signal to radio transmitting processing section 515.

Radio transmitting processing section 515 performs transmission processing such as D/A conversion, amplification and up-conversion on the control signal received as input from modulation section 514, and transmits the control signal after transmission processing from antennas 501-1 to 501-M.

Now, the mapping control processing in mapping control section 402 and the mapping processing in mapping section 403 in transmitting-side radio communication apparatus 400 will be described in detail.

Here, transmitting-side radio communication apparatus 400 maps codewords #0 to #3 to four streams #1 to #4, respectively. Specifically, codeword #0 is mapped to stream #1, codeword #1 is mapped to stream #2, codeword #2 is mapped to stream #3, and codeword #3 is mapped to stream #4. Further, each codeword is divided into four code blocks #0 to #3. Further, among streams #1 to #4, CQI for stream #1 is the lowest and less than a predetermined threshold value. Meanwhile, CQIs for streams #2 to #4 are equal to or more than the predetermined threshold value and CQI for stream #4 is the highest. Further, among code blocks #0 to #3 in codeword #0, filler bits are inserted in code blocks #1 to #3. Further, in codeword #0, the descending order of the number of filler bits is code block #3, code block #2 and code block #1.

Then, in stream #1 in which CQI is less than a predetermined threshold value and the lowest among streams #1 to #4, mapping control section 402 extracts code blocks #0 to #3 in codeword #0 in order from the code block with the smallest number of filler bits. Accordingly, mapping control section 402 extracts the code blocks in codeword #0 mapped to stream #1, in order of code block #0 in which the number of filler bits is zero, code block #1 in which the number of filler bits is smaller than in code blocks #2 and #3, code block #2 in which the number of filler bits is smaller than in code block #3, and code block #3 with the largest number of filler bits. That is, the order of code blocks in codeword #0 mapped in order from the head of stream #1 in a physical channel resource block is, code block #0, code block #1, code block #2 and code block #3.

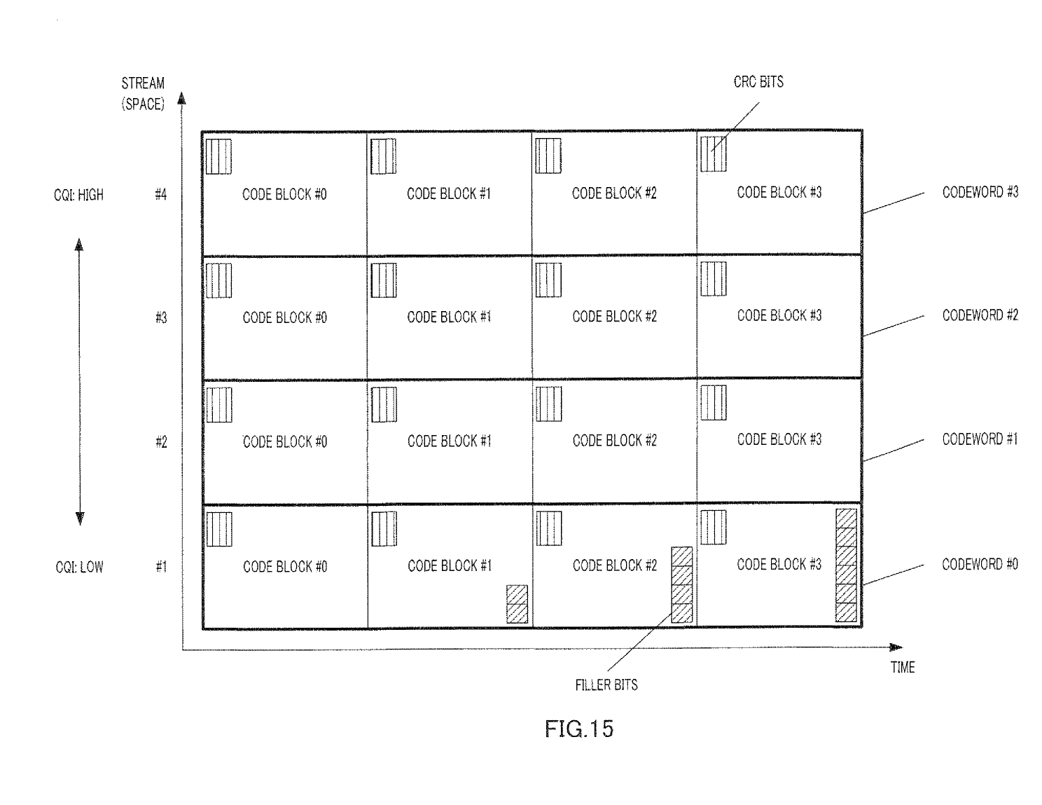

Then, as shown in FIG. 15, mapping section 403 maps the code blocks in order of code block #0, code block 41, code block #2 and code block #3 in codeword #0 in order from the head of stream #1 in the physical channel resource block.

By this means, in stream #1, in which CQI is the lowest, that is, stream #1 in which channel quality is the poorest among streams #1 to #4, receiving-side radio communication apparatus 500 receives code blocks in order from the code block with the smallest number of filler bits, that is, in order from the code block that is more likely to include errors. By this means, in stream #1, as in Embodiment 1, codeword errors are detected with increased reliability by a smaller number of decoding trials.

Further, transmitting-side radio communication apparatus 400 maps a codeword formed with code blocks in which filler bits are inserted, to the stream of the lowest CQI. Accordingly, in receiving-side radio communication apparatus 500, by decoding code blocks using filler bits in the stream of the lowest CQI, decoding performance, that is, error rate performance, improves. In other words, in receiving-side radio communication apparatus 500, the improvement of decoding performance resulting from the number of filler bits makes it possible to correct the variance of the SINR of the stream of the lowest CQI. By this means, the variance of the SINR of the lowest CQI becomes smaller, so that it is possible to improve MCS set information calculated based on an average SINR.

In this way, according to the present embodiment, in the stream in which CQI is the lowest among a plurality of streams, the transmitting-side radio communication apparatus maps a plurality of code blocks in order from the code block with the smallest number of filler bits, in order from the head of physical channel resources. By this means, the receiving-side radio communication apparatus is able to decode code blocks in order from the code block that is likely to include errors in the stream of the lowest CQI, so that, as in Embodiment 1, codeword errors are detected with increased reliability by a smaller number of decoding trials. Further, the transmitting-side radio communication apparatus maps a codeword in which filler bits are inserted, to the stream of the lowest CQI. Accordingly, the receiving-side radio communication apparatus performs decoding using filler bits in the stream of the lowest CQI, so that it is possible to improve the received quality of the stream of the lowest CQI. Accordingly, in the receiving-side radio communication apparatus, it is possible to improve reception performance for the stream of the lowest CQI and reduce the number of times of decoding trial even when there is an error in a code block. Consequently, according to the present embodiment, even when MIMO transmission is employed, it is possible to reduce power consumption in decoding processing as in. Embodiment 1.

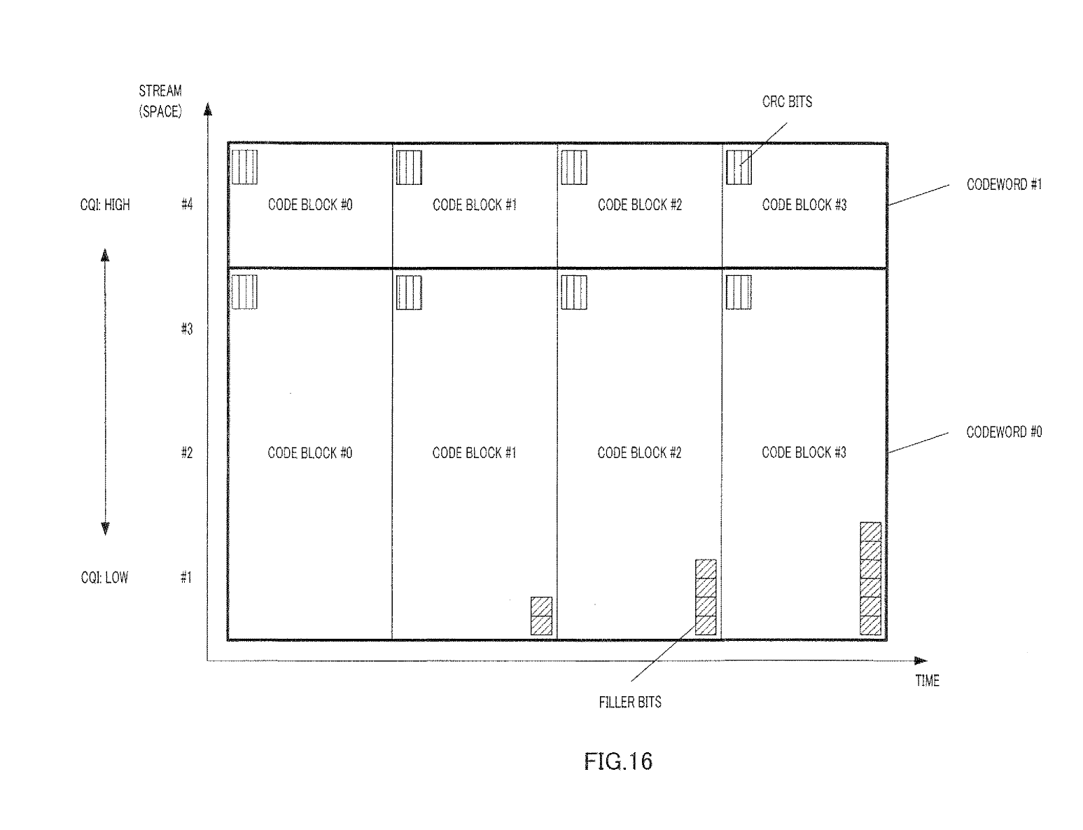

Although a case has been explained with the present embodiment where transmitting-side radio communication apparatus 400 maps one codeword to one stream, with the present invention, transmitting-side radio communication apparatus 400 may map one codeword to a plurality of streams. For example, as shown in FIG. 16, transmitting-side radio communication apparatus 400 may map codeword #0 over streams #1 to #3. In FIG. 16, streams #1 to #3 are regarded as one stream. Accordingly, in streams #1 to #3 in which CQI is the lowest among streams #1 to #4, transmitting-side radio communication apparatus 400 maps code blocks #0 to #3 in codeword #0 in order from the code block with the smallest number of filler bits. By this means, even when one codeword is mapped to a plurality of streams, the same advantage can be provided as in the present embodiment.

Further, although a case has been explained with the present embodiment where four streams are used, the number of streams is not limited to four, and, the present invention may be applicable to a case where any number of streams other than four is used.

Further, a case has been explained with the present embodiment where the transmitting-side radio communication apparatus reports mapping information to the receiving-side radio communication apparatus. Here, the mapping information informed from the transmitting-side radio communication apparatus to the receiving-side radio communication apparatus may be the information showing all results of mapping each stream to code blocks, and furthermore, the mapping information includes boundary position information showing a boundary position (e.g. stream number) between a stream mapped in order (ascending order) from the code block with the smallest number of filler bits and a stream mapped and in order (descending order) from the code block with the largest number of filler bits, and mapping order information showing an order to map (ascending order or descending order of the number of filler bits) code blocks in a stream of lower CQI than in the boundary position (or a stream of higher CQI than in the boundary position).

Further, with the present invention, the transmitting-side radio communication apparatus may not report mapping information to the receiving-side radio communication apparatus. For example, the transmitting-side radio communication apparatus and the receiving-side radio communication apparatus may hold a mapping table in advance showing the order to map (ascending order or descending order of the number of filler bits) code blocks per stream determined based on the number of streams. By this means, the transmitting-side radio communication apparatus maps code blocks to streams based on the number of filer bits inserted in the code blocks, the mapping table and the number of streams fed back from the receiving-side radio communication apparatus. Further, the receiving-side radio communication apparatus calculates demapping information based on the number of streams and the mapping table.

Further, with the present invention, based on CQIs for streams, the number of streams and so on, the receiving-side radio communication apparatus generates mapping information showing an order to map code blocks in each stream (ascending order or descending order of the number of filler bits) and may feed back the mapping information to the transmitting-side radio communication apparatus. The transmitting-side radio communication apparatus maps code blocks based on the number of filler bits inserted in the code blocks and the feedback mapping information.

Further, with the present invention, the transmitting-side radio communication apparatus may not report mapping information to the receiving-side radio communication apparatus and the receiving-side radio communication apparatus may specify the mapping information blindly. For example, the transmitting-side radio communication apparatus determines the order to map code blocks in each stream (ascending order or descending order of the number of filler bits) based on information about streams fed back from the receiving-side radio communication apparatus (e.g. CQIs and the number of streams) and maps the code blocks to each stream. Further, by specifying the order to map code blocks in each stream (ascending order or descending order of the number of filler bits) based on information about streams (e.g. CQIs and the number of streams) blindly, the receiving-side radio communication apparatus restores the code blocks mapped to each stream.

Further, in FIG. 14, by replacing four antennas 501-1 to 501-4 and four codeword processing sections 506-1 to 506-4 with one antenna and one codeword processing section and by replacing signal demultiplexing section 503 with a signal detection section that detects a signal for receiving one stream, it is possible to configure a receiving-side radio communication apparatus in SISO (Single-Input Single-Output) transmission in which one antenna is each provided both on the transmitting side and the receiving side, that is, a receiving-side radio communication apparatus associated with transmitting-side radio communication apparatus 100 in Embodiment 1 (FIG. 1).

### Embodiment 6

With the present embodiment, a case where a receiving-side radio communication apparatus carries out SIC reception will be explained.

The receiving-side radio communication apparatus that carries out SIC reception performs SIC receiving processing, which filters and cancels a plurality of space-multiplexed streams in order from the stream of the highest CQI. Further, with SIC reception, error rate performance further improves when the difference in received quality between streams increases. That is, when a receiving-side radio communication apparatus performs SIC reception, by increasing the difference in received quality between streams, SIC performance, that is, error rate performance, improves. As described above, by using high LLRs of filler bits to decode a code block in which filler bits are inserted, it is possible to improve received quality. That is, received quality difference is produced between code blocks in which filler bits are inserted and code blocks in which filler bits are not inserted. Accordingly, to increase the difference in received quality between streams, code blocks in which filler bits are inserted may be mapped to streams of high CQIs and code blocks in which filler bits are not inserted may be mapped to streams of low CQIs.

Then, with the present embodiment, in a stream in which CQI is less than a predetermined threshold value among a plurality of streams, similar to Embodiment 5, a plurality of code blocks are mapped in order from the code block with the smallest number of filler bits. In addition, with the present embodiment, in a stream in which CQI is equal to or more than the predetermined threshold value, a plurality of code blocks are mapped in order from the code block with the largest number of filler bits.

### Mapping Example 1

With this mapping example, in the stream in which CQI is the lowest among a plurality of streams, similar to Embodiment 5, a plurality of code blocks are mapped in order from the code block with the smallest number of filler bits. Further, with this mapping example, in streams other than the stream of the lowest CQI, a plurality of code blocks are mapped in order from the code block with the largest number of filler bits.

Now, a detailed explanation will be provided below. Here, transmitting-side radio communication apparatus 400 (FIG. 13) maps codewords #0 to #3 to four streams #1 to #4 as in Embodiment 5. Further, each codeword is divided into four code blocks #0 to #3. Further, among streams #1 to #4, the CQI for stream #1 is the lowest and the CQI for stream #4 is the highest. While the CQIs for streams #2 to #4 are equal to or more than the predetermined threshold value, the CQI for stream #1 is less than the predetermined threshold value and much lower than the CQIs for streams #2 to #4. Further, among code blocks #0 to #3 in codeword #0, filler bits are inserted in code blocks #1 to #3, Further, in codeword #0, the descending order of the number of filler bits is, code block #3, code block #2 and code block #1. Further, among code blocks #0 to #3 in codewords #1 to #3, filler bits are inserted in code blocks #0 to #2. Further, in codewords #1 to #3, the descending order of the number of filler bits is, code blocks #0, code blocks #1 and code blocks #2.

In stream #1 in which the CQI is the lowest among streams #1 to #4, similar to Embodiment 5, mapping control section 402 extracts a plurality of code blocks in order from the code block with the smallest number of filler bits.

Meanwhile, in streams #2 to #4 other than stream #1 in which the CQI is the lowest among streams #1 to #4, mapping control section 402 extracts a plurality of code blocks in order from the code block with the largest number of filler bits. That is, mapping control section 402 extracts the code blocks in codewords #1 to #3 mapped to streams #2 to #4, respectively, in order of code blocks #0, in which the number of filler bits is the largest, code blocks #1, in which the number of filler bits is the second largest, code blocks #2, in which the number of filler bits is the third largest, and code blocks #3, in which the number of filler bits is zero.

That is, the order of code blocks mapped in order from the head of stream #1 of the physical channel resource block is, code block #0, code block #1, code block #2 and code block #3 in codeword #0. Further, the order of code blocks mapped in order from the head of streams #2 to #4 of the physical channel resource block is, code blocks #0, code blocks #1, code blocks #2 and code blocks #3 in codewords #1 to #3.

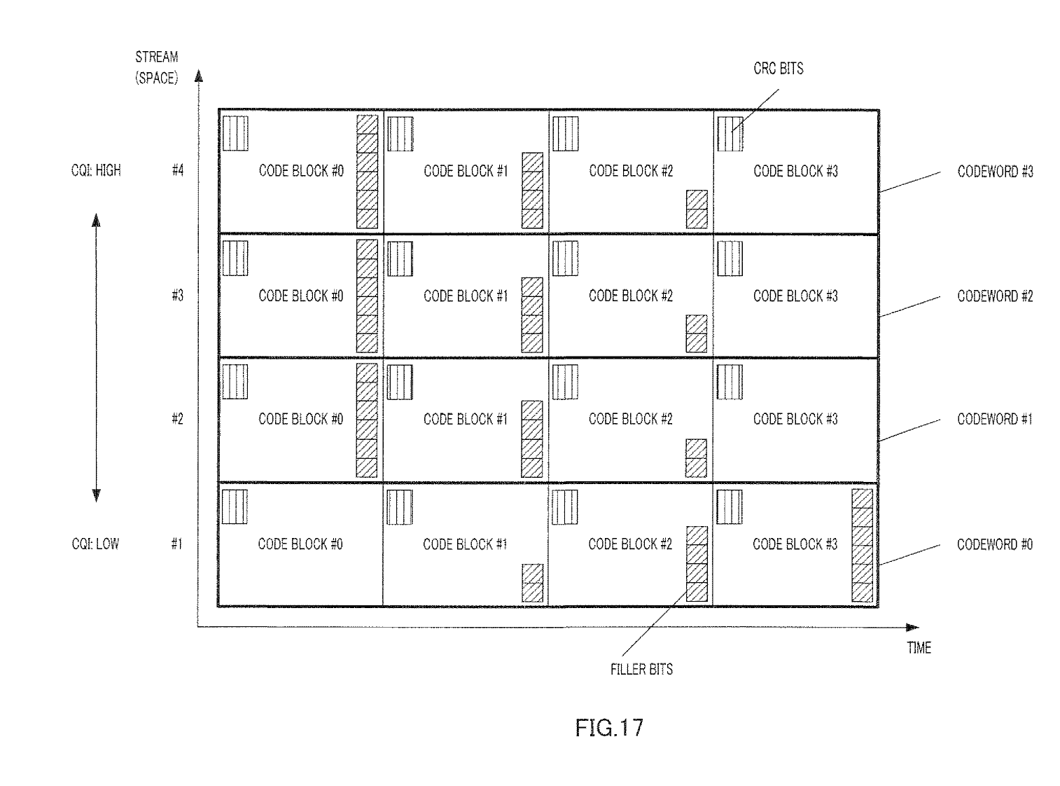

As shown in FIG. 17, mapping section 403 maps the code blocks in order of code block #0, code block #1, code block #2 and code block #3 in codeword #0 in order from the head of stream #1 in the physical channel resource block. Further, as shown in FIG. 17, mapping section 403 maps the code blocks in order of code blocks #0, code blocks #1, code blocks #2 and code blocks #3 in codewords #1 to #3 in order from the head of streams #2 to #4 in the physical channel resource block.

By this means, in streams #2 to #4 in which the CQIs are much higher than in stream #1, receiving-side radio communication apparatus 500 (FIG. 14) receives code blocks in order from the code block with the largest number of filler bits, and receives code blocks in order from the code block with the smallest number of filler bits in stream #1 in which the CQI is the lowest. By this means, among streams #2 to #4, receiving-side radio communication apparatus 500 decodes a code block received earlier using more filler bits, so that it is possible to improve received quality. That is, the difference in received quality between stream #1 and streams #2 to #4 becomes greater at an earlier time. Therefore, in receiving-side radio communication apparatus 500, it is possible to improve SIC reception performance, that is, error rate performance at an earlier time.

Further, in stream #1 in which the CQI is the lowest, similar to Embodiment 5, receiving-side radio communication apparatus 500 extracts a plurality of code blocks in order from the code block with the smallest number of filler bits. Consequently, even when receiving-side radio communication apparatus 500 cancels interference using SIC and yet errors occur in a code block, codeword errors are detected with increased reliability by a smaller number of decoding trials, and it is possible to reduce the number of times of decoding trial.

### Mapping Example 2

With this mapping example, in streams other than the stream in which the CQI is the highest among a plurality of streams, a plurality of code blocks are mapped in order from the code block with the smallest number of filler bits. Further, with this mapping example, in the stream of the highest CQI, a plurality of code blocks are mapped in order from the code block with the largest number of filler bits.

Now, a detailed explanation will be provided below. Here, transmitting-side radio communication apparatus 400 maps codewords #0 to #3 to four streams #1 to #4 as in Embodiment 5. Further, each codeword is divided into four code blocks #0 to #3. Further, among streams #1 to #4, the CQI for stream #1 is the lowest and the CQI for stream #4 is the highest. While the CQIs for streams #1 to #3 are less than a predetermined threshold value, the CQI for stream #4 is equal to or more than the predetermined threshold value and much higher than the CQIs for streams #1 to #3. Further, among code blocks #0 to #3 in codewords #0 to #2, filler bits are inserted in code blocks #1 to #3. Further, in codewords #0 to #2, the descending order of the number of filler bits is, code blocks #3, code blocks #2 and code blocks #1. Further, among code blocks #0 to #3 in codeword #3, filler bits are inserted in code blocks #0 to #2. Further, in codeword #3, the descending order of the number of filler bits is code block #0, code block #1 and code block #2.

In streams #1 to #3 other than stream #4 in which the CQI is the highest among streams #1 to #4, mapping control section 402 maps code blocks #0 to #3 in codewords #0 to #2 in order from the code block with the smallest number of filler bits. Meanwhile, in stream #4 in which the CQI is the highest among streams #1 to #4, mapping control section 402 extracts code blocks #0 to #3 in codeword #3 in order from the code block with the largest number of filler bits.

Accordingly, mapping control section 402 each extracts the code blocks in codewords #0 to #2 mapped to streams #1 to #3 in order of code blocks #0, in which the number of filler bits is zero, code blocks #1, in which the number of filler bits is smaller than in code blocks #2 and #3, code blocks #2, in which the number of filler bits is smaller than in code blocks #3, and code blocks #3 with the largest number of filler bits. That is, the order of code blocks mapped in order from each head of streams #1 to #3 of the physical channel resource block is, code blocks 40, code blocks #1, code blocks #2 and code blocks #3.

Meanwhile, mapping control section 402 extracts the code blocks in codeword #3 mapped to stream #4, in order of code block #0 in which the number of filler bits is the largest, code block #1 in which the number of filler bits is the second largest, code block #2 in which the number of filler bits is the third largest, and code block #3 in which the number of filler bits is zero. That is, the order of code blocks mapped in order from the head of stream #4 of the physical channel resource block is, code block #0, code block #1, code block #2 and code block #3 in codeword #3.

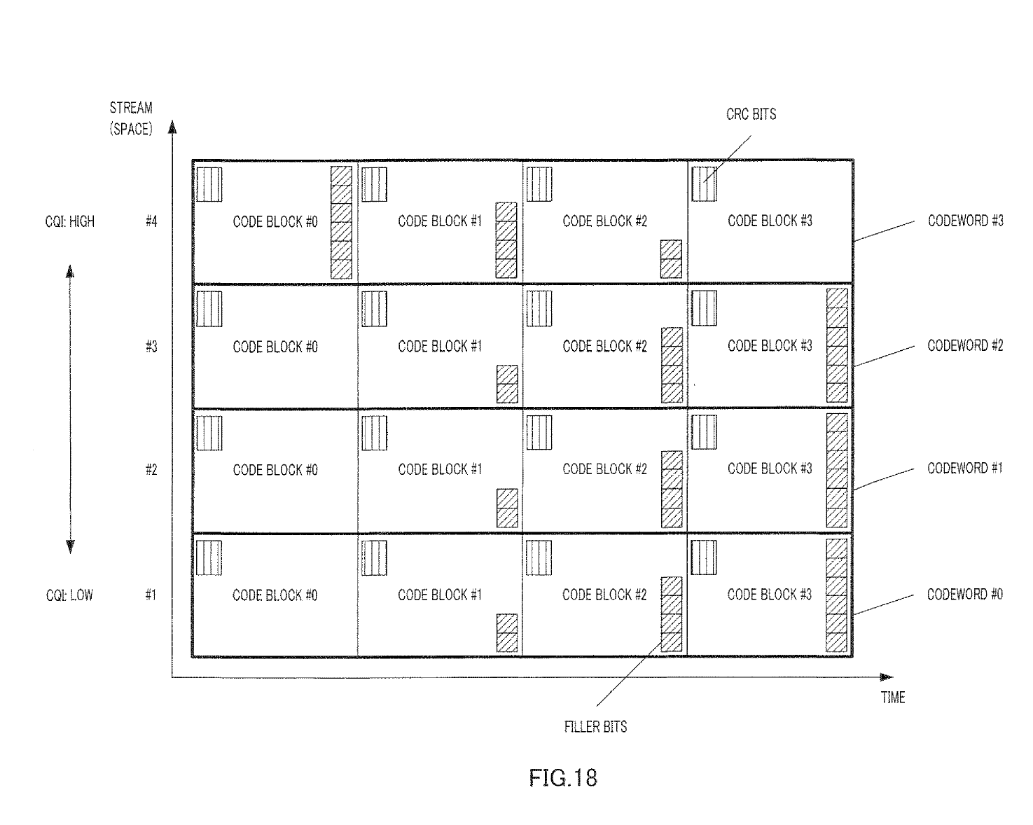

As shown in FIG. 18, mapping section 403 maps the code blocks in order of code blocks #0, code blocks #1, code blocks #2 and code blocks #3 in codewords #0 to #2 in order from each head of streams #1 to #3 in the physical channel resource block. Then, as shown in FIG. 18, mapping section 403 maps the code blocks in order of code block #0, code block #1, code block #2 and code block #3 in codeword #3 in order from the head of stream #4 in the physical channel resource block.

By this means, in stream #4 in which the CQI is much higher than in streams #1 to #3, receiving-side radio communication apparatus 500 (FIG. 14) receives code blocks in order from the code block with the largest number of filler bits, and receives code blocks in order from the code block with the smallest number of filler bits in streams #1 to #3. By this means, similar to mapping example 1, in stream #4, receiving-side radio communication apparatus 500 decodes a code block received earlier using more filler bits, so that it is possible to improve received quality. That is, the difference in received quality between streams #1 to #3 and received quality of stream #4 becomes greater when reception is earlier. Therefore, in receiving-side radio communication apparatus 500, it is possible to improve SIC reception performance, that is, error rate performance at an earlier time.

Further, in streams #1 to #3, similar to Embodiment 5, receiving-side radio communication apparatus 500 receives a plurality of code blocks in order from the code block with the smallest number of filler bits (i.e. code block that is more likely to include errors) Further, receiving-side radio communication apparatus 500 performs SIC processing in order from the stream of the highest CQI, that is, in order of stream #4, stream #3, stream #2 and stream #1. Consequently, even when receiving-side radio communication apparatus 500 cancels interference using SIC and yet errors occur in a code block, the errors are detected with increased reliability in a code block mapped at an earlier time and in an early stage of SIC processing (mapped to a stream of higher CQI). Therefore, it is possible to further reduce the number of times of decoding trial compared with mapping example 1.

Mapping example 1 and mapping example 2 have been explained.

In this way, according to the present embodiment, the transmitting-side radio communication apparatus transmits a plurality of code blocks in order from the code block with the largest number of filler bits in a stream in which CQI is high (i.e. a stream in which CQI is equal to or more than a predetermined threshold value), and transmits a plurality of code blocks in order from the code block with the smallest number of filler bits in a stream in which CQI is lower (i.e. a stream in which CQI is less than the predetermined threshold value). By this means, in the receiving-side radio communication apparatus, when SIC reception is carried out, it is possible to increase the difference in received quality between streams in an earlier time. Accordingly, in the receiving-side radio communication apparatus, it is possible to improve SIC performance at an earlier time. Further, the transmitting-side radio communication apparatus transmits a plurality of code blocks in order from the code block with the smallest number of filler bits (i.e. the code block that is more likely to include errors) in a stream in which the CQI is lower (i.e. a stream that is more likely to include errors). Accordingly, even when interference is canceled using SIC and yet errors occur, error can be detected in a code block with priority from the code block that is likely to include errors as in Embodiment 5, so that it is possible to reduce the number of times of decoding trial. Consequently, according to the present embodiment, even when a receiving-side radio communication apparatus performs SIC reception, it is possible to improve SIC reception performance and reduce power consumption in decoding processing as in Embodiment 1.

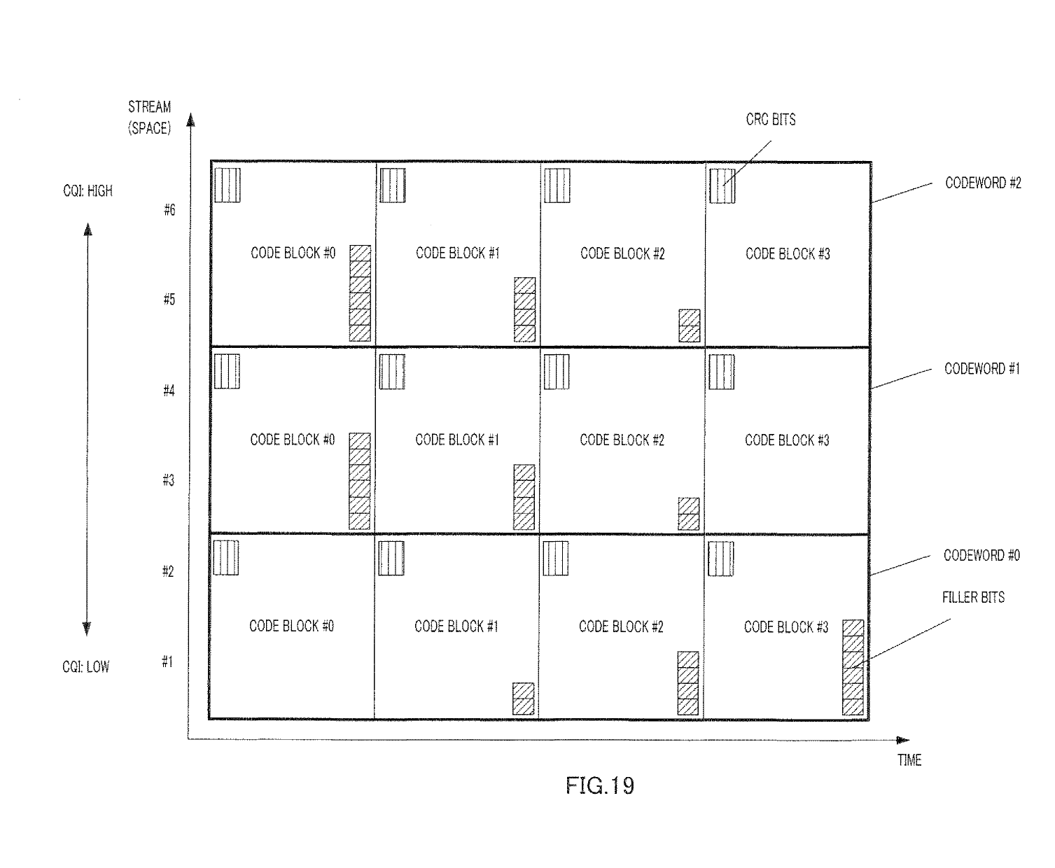

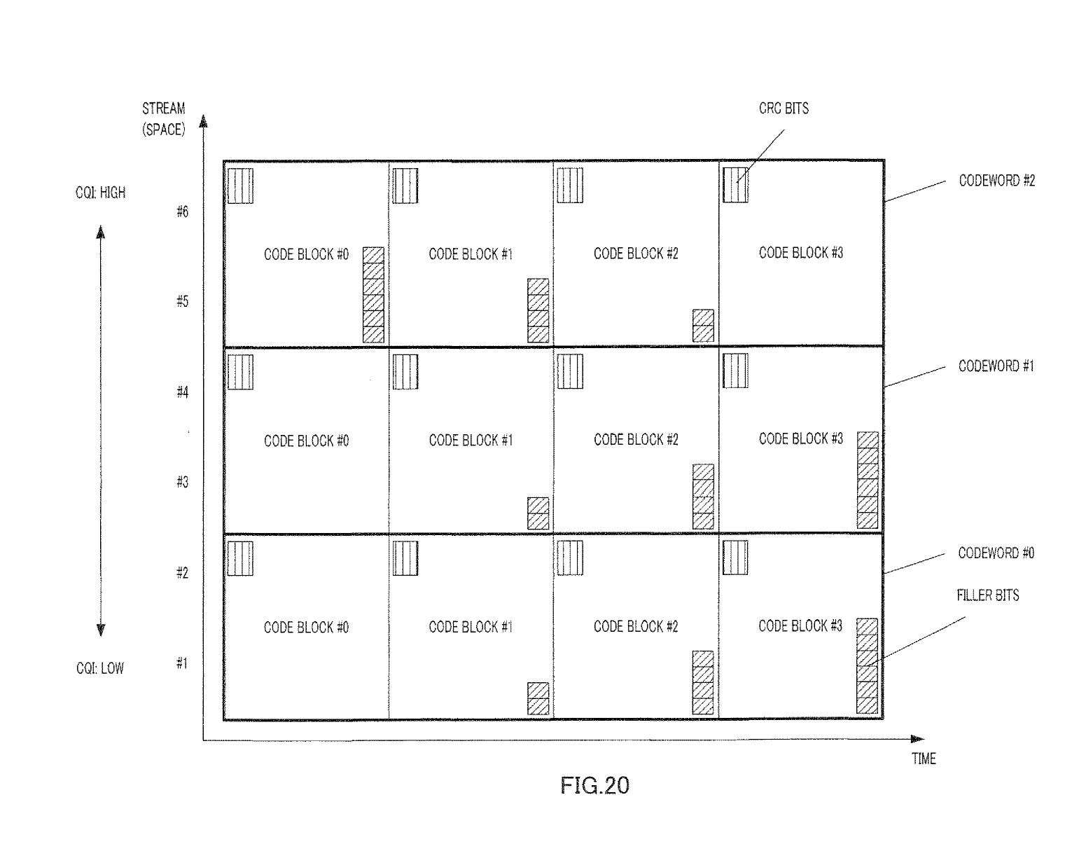

Although a case has been explained with the present embodiment where transmitting-side radio communication apparatus 400 maps one codeword to one stream, with the present invention, transmitting-side radio communication apparatus 400 may map one codeword to a plurality of streams. For example, as shown in FIGS. 19 and 20, transmitting-side radio communication apparatus 400 may map codeword #0 to two streams #1 and #2, map codeword #1 to two streams #3 and #4 and map codeword #2 to two streams #5 and #6. In FIGS. 19 and 20, streams #1 and #2, streams #3 and #4 and streams #5 and #6 are each regarded as one stream.

For example, as shown in FIG. 19, in streams #1 and #2 in which the CQIs are the lowest among streams #1 to #6, transmitting-side radio communication apparatus 400 according to mapping example 1 of the present embodiment maps code blocks #0 to #3 in codeword #0 in order from the code block with the smallest number of filler bits. By contrast with this, in streams #3 and #4 and streams #5 and #6 other than streams #1 and #2 in which the CQIs are the lowest, transmitting-side radio communication apparatus 400 maps code blocks #0 to #3 in codewords #1 and #2 in order from the code block with the largest number of filler bits.

Further, as shown in FIG. 20, in streams #1 and #2 and streams #3 and #4 other than streams #5 and #6 in which the CQIs are the highest among streams #1 to #6, transmitting-side radio communication apparatus 400 according to mapping example 2 of the present embodiment maps code blocks #0 to #3 in codewords #0 and #1 in order from the code block with the smallest number of filler bits. Meanwhile, in streams #5 and #6 in which the CQIs are the highest, transmitting-side radio communication apparatus 400 maps code blocks #0 to #3 in codeword #2 in order from the code block with the largest number of filler bits. Consequently, as shown in FIGS. 19 and 20, even when one codeword is mapped to a plurality of streams, the same advantage can be provided as in the present embodiment.

Further, although a case has been explained with the present embodiment where four streams are used, the number of streams is not limited to four, and, the present invention may be applicable to a case where any number of streams other than four is used.

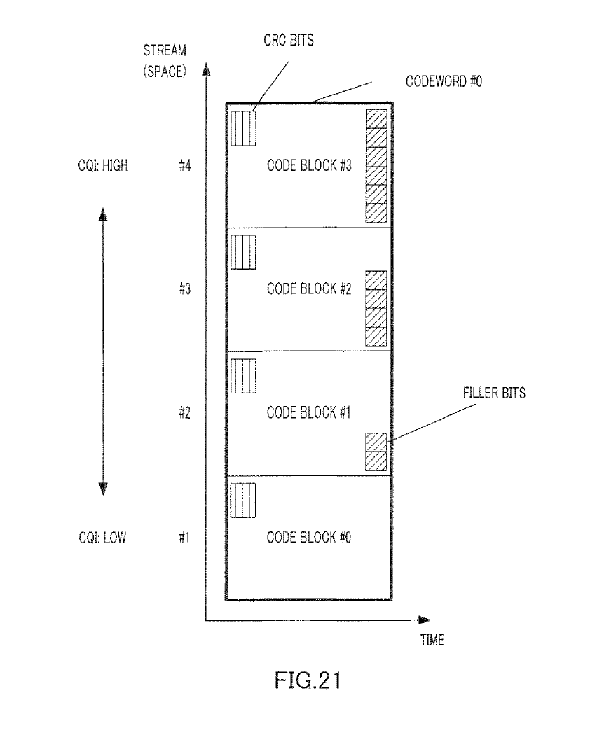

Although a case has been explained with the present embodiment where the transmitting-side radio communication apparatus maps code blocks to a physical channel resource block represented in the time domain and in streams (the spatial domain), with the present invention, a transmitting-side radio communication apparatus may map code blocks by taking into account the streams (the spatial domain) alone. For example, as shown in FIG. 21, a transmitting-side radio communication apparatus may map code blocks #0 to #3 in codeword #0 to streams, in order from the code block with the smallest number of filler bits and in order from the stream of the lowest CQI. By this means, many filler bits are inserted when the CQI for a stream is higher, so that received quality improves further. Therefore, with the receiving-side radio communication apparatus, the difference in received quality between streams increases further, so that it is possible to improve SIC reception performance, that is, error rate performance.

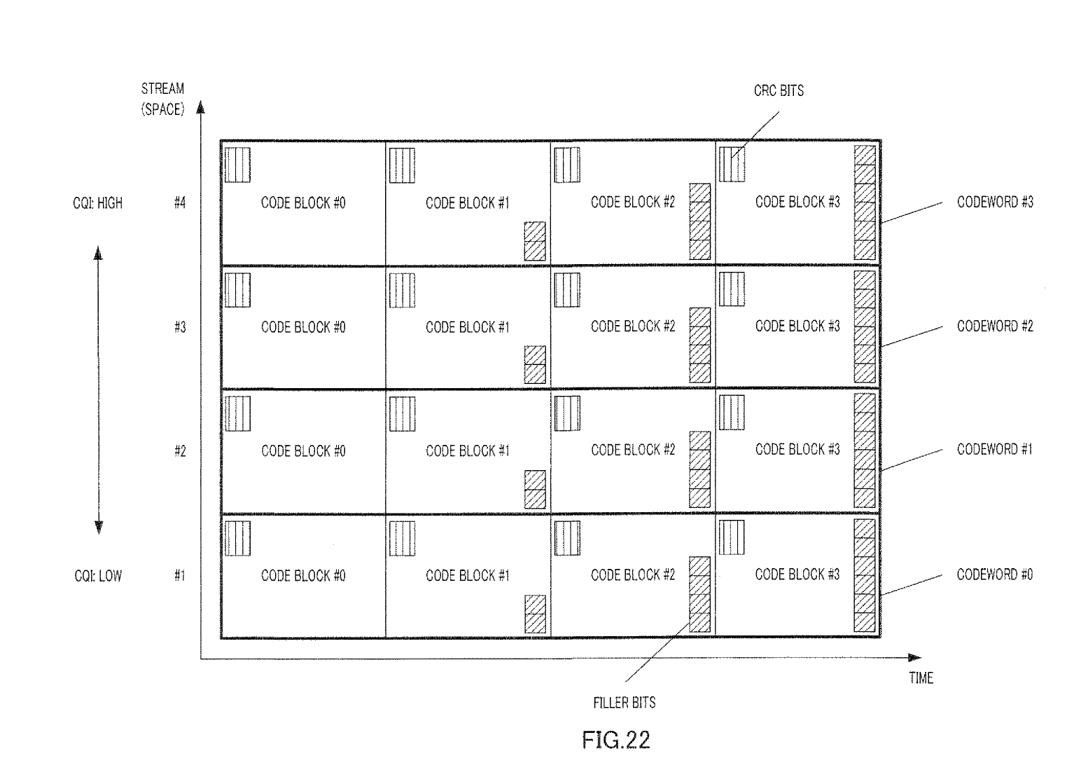

Although a case has been explained with the present embodiment where the receiving-side radio communication apparatus carries out SIC reception, with the present invention, a receiving-side radio communication apparatus may perform MLD (Maximum Likelihood Detection) or use PIC (Parallel Interference Canceller). When the receiving-side radio communication apparatus adopts MLD or PIC, error rate performance improves further when the difference in received quality between streams is smaller. Accordingly, as shown in FIG. 22, in all streams, the transmitting-side radio communication apparatus transmits a plurality of code blocks in order from the code block with the smallest number of filler bits. By this means, in the receiving-side radio communication apparatus, it is possible to improve MLD and PIC performance even when MLD or PIC is adopted. Further, even when interference is cancelled using MLD or PIC and yet errors occur, the receiving-side radio communication apparatus receives code blocks from the code block with the smaller number of filler bits in all streams, so that it is possible to reduce the number of times of decoding trial as in the present embodiment.

Further, although a case has been explained with the present embodiment where code blocks are mapped in order (ascending order) from the code block with the smallest number of filler bits in the stream of the lowest CQI (or the streams other than the stream in which the CQI is the highest), and code blocks are mapped in order (descending order) from the code block with the largest number of filler bits, in streams other than the stream of the lowest CQI (or the stream in which the CQI is the highest), with the present invention, the order of code block mapping, that is, a switch between ascending order and descending order of the number of filler bits may be set between any streams. For example, based on the CQIs for streams, streams to which code blocks are mapped in order from the smallest number of filler bits (in ascending order) and streams to which code blocks are mapped in order from the largest number of filler bits (in descending order) may be changed. To be more specific, the transmitting-side radio communication apparatus may map a plurality of code blocks in order from the code block with the smallest number of filler hits, in a stream in which the CQI is less than a predetermined threshold value among a plurality of streams. In addition, the transmitting-side radio communication apparatus may map a plurality of code blocks in order from the code block with the largest number of filler bits, in a stream in which the CQI is equal to or more than the predetermined threshold value. For example, when MIMO transmission in which SIC, PIC and MLD is used in combination in a hybrid manner, is employed, mapping processing for code blocks may be adequately changed according to the CQIs for streams and characteristics of the methods.

Embodiments of the present invention have been explained.

Although cases have been described with the above embodiments where CRC codes are used as error detection codes, the error detection codes that can be used in the present invention are not limited to CRC codes.

Although cases have been described with the above embodiments where the physical channel resources are represented in the time domain, in the frequency domain and in streams (the spatial domain), the physical channel resources are not limited to the time domain, the frequency domain and the spatial domain, and may be represented in codes.

Further, filler bits used in the above embodiments may be “0”s and “1”s as long as the filler bits are known between the transmitting-side radio communication apparatus and the receiving-side radio communication apparatus.

Further, in a mobile communication system, transmitting-side radio communication apparatuses 100 (FIG. 1), 200 (FIG. 7), 300 (FIG. 10), 400 (FIG. 13) or receiving-side radio communication apparatus 500 (FIG. 14) may be provided in a radio communication base station apparatus. Further, transmitting-side radio communication apparatuses 100 (FIG. 1), 200 (FIG. 7), 300 (FIG. 10), 400 (FIG. 13) or receiving-side radio communication apparatus 500 (FIG. 14) may be provided in a radio communication mobile station apparatus. By this means, it is possible to realize a radio communication base station apparatus and radio communication mobile station apparatus providing an advantage as described above.

Further, a radio communication mobile station apparatus may be referred to as a “UE,” and a radio communication base station apparatus may be referred to as a “Node B” or “BS (base station).”

Further, although cases have been explained with the above embodiments where, when MIMO transmission is employed (Embodiments 5 and 6), downlink/uplink single-user MIMO transmission in a single site (one cell) (i.e. MIMO transmission between a plurality of antennas in one BS and a plurality of antennas in one UE) is carried out, MIMO transmission applicable to the present invention is not limited to downlink/uplink single-user MIMO transmission in a single site.

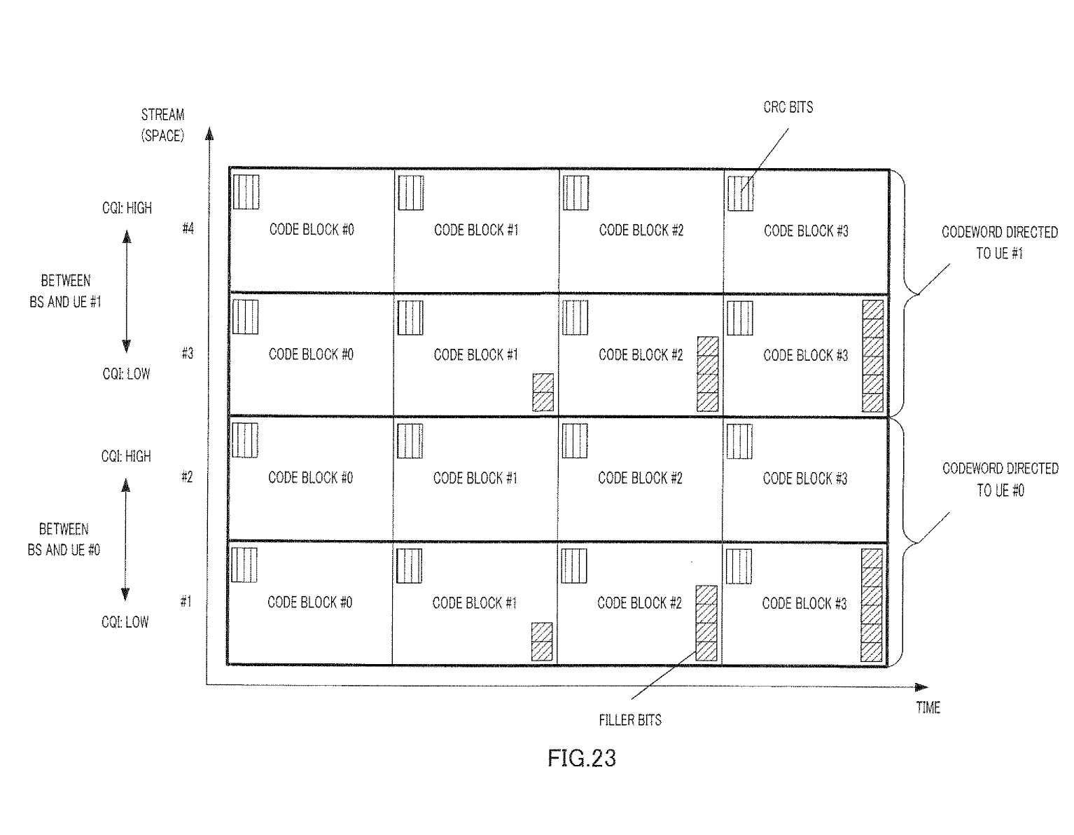

For example, the present invention may be applied to each link (each channel) between a BS and UEs in downlink/uplink multiuser MIMO transmission in a single site (i.e. MIMO transmission between a plurality of antennas in one BS and a plurality of antennas in a plurality of UEs). For example, a BS (transmitting-side radio communication apparatus) may perform spatial multiplexing transmission for data (codewords) to UEs (receiving-side radio communication apparatuses) using a plurality of streams. To be more specific, as shown in FIG. 23, the BS maps a codeword directed to UE #0 to streams #1 and #2, maps a codeword directed to UE #1 to streams #3 and #4 in streams #1 to #4. Then, similar to the above embodiments, based on the CQIs for streams per UE, the BS maps a plurality of code blocks to a physical channel resource block. In FIG. 23, similar to Embodiment 5, the BS transmits codewords mapped to the streams of the lowest CQI (streams #1 and #3) among streams mapped to codewords directed to UEs, in order from the code block with the smallest number of filler bits.

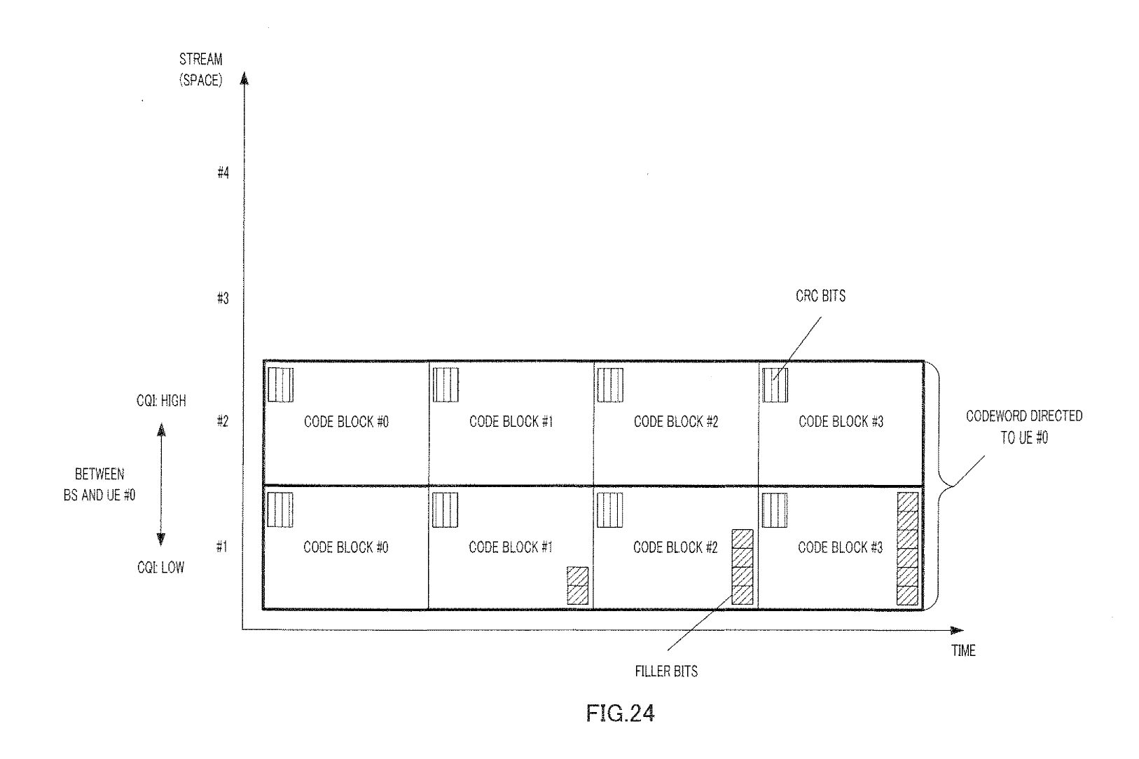

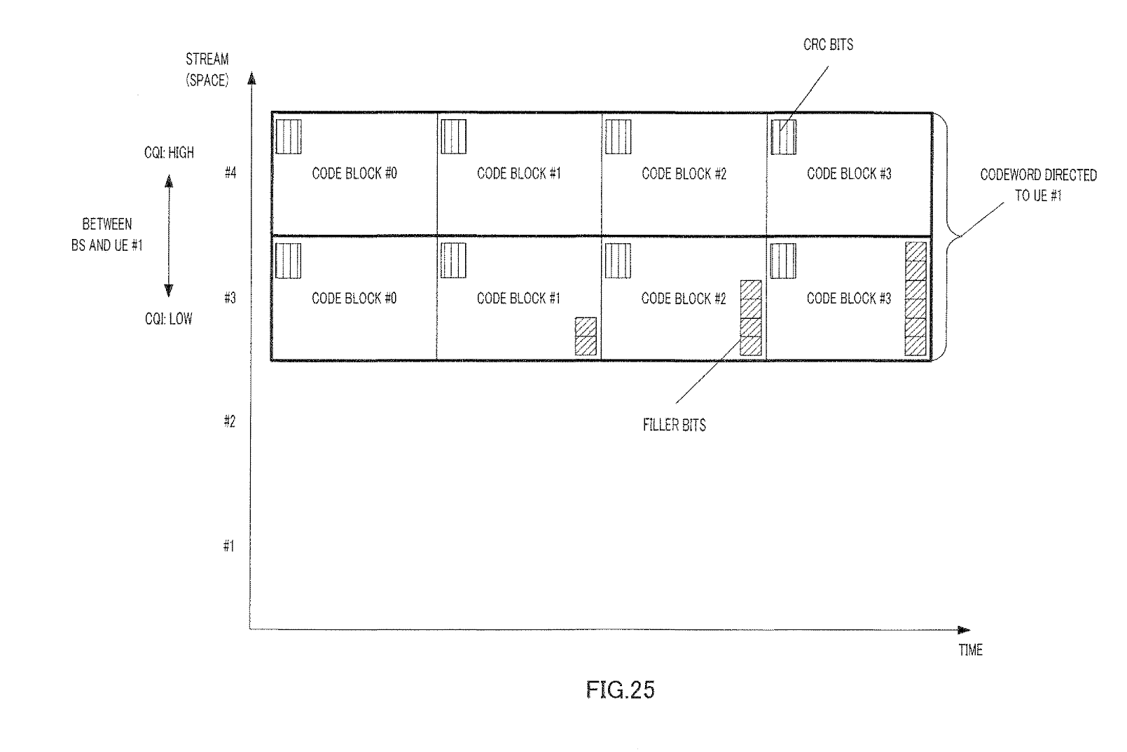

Further, in uplink multiuser MIMO transmission in a single site, UEs (transmitting-side radio communication apparatuses) may perform spatial multiplexing transmission for data (codewords) to a BS (receiving-side radio communication apparatus) using a plurality of streams. Specifically, as shown in FIG. 24, UE #0 maps a codeword to streams #1 and #2 among streams #1 to #4. Further, as shown in FIG. 25, UE #1 maps a codeword to streams #3 and #4 among streams #1 to #4. Then, similar to the above embodiments, based on the CQIs for streams per UE, UEs #0 and #1 map a plurality of code blocks to physical channel resource blocks. In FIGS. 24 and 25, similar to Embodiment 5, UEs #0 and #1 transmit codewords mapped to the streams of the lowest CQI (streams #1 and #3) among streams mapped to codewords, in order from the code block with the smallest number of filler bits.

Further, the present invention may be applied between a plurality of BSs and a plurality of UEs in downlink/uplink single-user/multiuser MIMO transmission in multiple sites (i.e. MIMO transmission between a plurality of antennas in a plurality of BSs and a plurality of antennas in one UE or a plurality of UEs) and the present invention may be applied between each BS and each UE.

Further, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSIs, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosures of Japanese Patent Application No. 2007-256085, filed on Sep. 28, 2007, and Japanese Patent Application No. 2008-174758, filed on Jul. 3, 2008 including the specifications, drawings and abstracts, are incorporated herein by reference in their entirety.

### INDUSTRIAL APPLICABILITY

The present invention is applicable to, for example, mobile communication systems.

1. A radio communication apparatus comprising:
a division section that divides a bit sequence, in which known bits are inserted, into a plurality of code blocks; and
a mapping section that maps the plurality of code blocks in order from a code block with a smallest number of known bits, in order from a head of physical channel resources.

2. The radio communication apparatus according to claim 1, wherein the mapping section maps the plurality of code blocks of different block sizes in order from a code block of a smallest code block size and, in order from a code block with a smallest number of known bits when there are a plurality of code blocks of a same block size.

3. The radio communication apparatus according to claim 1, wherein the mapping section maps the plurality of code blocks of different block sizes in order from a code block with a smallest number of known bits, and in order from a code block of a smallest code block size when there are a plurality of code blocks with a same number of known bits.

4. The radio communication apparatus according to claim 1, wherein the mapping section maps the plurality of code blocks having different coding rates in order from a code block having a highest coding rate, and in order from a code block with a smallest number of known bits when there are a plurality of code blocks having a same coding rate.

5. The radio communication apparatus according to claim 1, wherein the mapping section maps the plurality of code blocks having different coding rates in order from a code block with a smallest number of known bits, and in order from a code block having a highest coding rate when there are a plurality of code blocks with a same number of known bits.

6. The radio communication apparatus according to claim 1, wherein the mapping section maps the plurality of code blocks to which different frequency bandwidths are allocated, in order from a code block in a narrowest frequency bandwidth, and in order from a code block with a smallest number of known bits when there are a plurality of code blocks in a same frequency bandwidth.

7. The radio communication apparatus according to claim 1, wherein the mapping section maps the plurality of code blocks to which different frequency bandwidths are allocated, in order from a code block with a smallest number of known bits, and in order from a code block in a narrowest frequency bandwidth when there are a plurality of code blocks with a same number of known bits.

8. The radio communication apparatus according to claim 1 further comprising a plurality of antennas that transmit the plurality of code blocks using a plurality of streams,
wherein, in a stream having lower channel quality than a threshold value among the plurality of streams, the mapping section maps the plurality of code blocks in order from a code block with a smallest number of known bits.

9. The radio communication apparatus according to claim 8, wherein, in a stream having equal or higher channel quality than the threshold value, the mapping section maps the plurality of code blocks in order from a code block with a largest number of known bits.

10. The radio communication apparatus according to claim 8, wherein, in a stream having a lowest channel quality among the plurality of streams, the mapping section maps the plurality of code blocks in order from a code block with a smallest number of known bits.

11. The radio communication apparatus according to claim 10, wherein, in streams other than the stream having the lowest channel quality among the plurality of streams, the mapping section maps the plurality of code blocks in order from code blocks with a largest number of known bits.

12. The radio communication apparatus according to claim 8, wherein, in streams other than a stream having a highest channel quality among the plurality of streams, the mapping section maps the plurality of code blocks in order from code blocks with a smallest number of known bits.

13. The radio communication apparatus according to claim 12, wherein, in the stream having the highest channel quality among the plurality of streams, the mapping section maps the plurality of code blocks in order from a code block with a largest number of known bits.

14. A mapping method comprising mapping a plurality of code blocks generated by dividing a bit sequence in which known bits are inserted, in order from a code block with a smallest number of known bits or from a code block showing a poorest error rate performance, in order from a head of physical channel resources.
